(19) United States
(12) Patent Application Publication
(10) Pub. No.: US 2020/0269479 A1
(43) Pub. Date: Aug. 27, 2020

(54) BONDING MEMBER AND BONDING MEMBER MANUFACTURING METHOD

(71) Applicant: MITSUBISHI HEAVY INDUSTRIES, LTD., Tokyo (JP)

(72) Inventors: Takahiro TACHIBANA, Tokyo (JP); Ryoji OKABE, Tokyo (JP); Koichi HASEGAWA, Tokyo (JP); Yasuyuki FUJIYA, Tokyo (JP)

(21) Appl. No.: 16/668,113

(22) Filed: Oct. 30, 2019

(30) Foreign Application Priority Data
Feb. 25, 2019 (JP) 2019-031265

(51) Int. Cl. B29C 45/14; B33Y 80/00

(52) U.S. Cl. CPC B29C 45/14; B29K 2705/00; B33Y 80/00

(57) ABSTRACT

A bonding member according to an embodiment includes: a metal member including a first base portion made of metal and a first engagement portion made of metal and provided integrally with the first base portion; and a resin member including a second base portion made of resin and a second engagement portion made of resin and provided integrally with the second base portion so as to engage with the first engagement portion. The first engagement portion includes a three-dimensional structure formed by a frame to form a plurality of cavities communicating with each other inside the frame, and the second engagement portion includes a resin filled in the plurality of cavities of the three-dimensional structure. A ratio of the frame per unit volume including the cavity and the frame in the first engagement portion gradually increases toward the first base portion while fluctuating.

### TECHNICAL FIELD

The present disclosure relates to a bonding member and a bonding member manufacturing method.

### BACKGROUND

A bonding member obtained by bonding a metal material and a resin material, for example, can be used in various uses as a material having the characteristics of a metal and the characteristics of a resin. In such a bonding member of a metal material and a resin material, different materials including a metal and a resin need to be bonded with a sufficient bonding strength.

However, an adhesion strength in a bonding interface between a metal and a resin may decrease when oxidation of a metal or the like occurs due to the influence of moisture present in the bonding interface, for example.

Therefore, in order to secure a bonding strength between a metal material and a resin material regardless of an adhesion strength in a bonding interface between a metal and a resin, a resin material and a metal material each may have a parallel-cross structure, and the resin material and the metal material may be bonded so as to be embedded in the gaps of the parallel-cross structures (for example, see Patent Document 1).

### CITATION LIST

### Patent Literature

Patent Document 1: WO2017/082207A

### SUMMARY

In the bonding member disclosed in Patent Document 1, electroless plating and electroplating are performed on the parallel-cross structure made of resin so that the parallel-cross structure made of a metal material is formed in the gap of the parallel-cross structure made of resin.

However, in the bonding member disclosed in Patent Document 1, it is difficult to form a large portion having a thickness exceeding several tens of mm, for example, even if it is tried to form a portion made of a metal material in the parallel-cross structure made of a metal material using electroplating. Moreover, when a metallic member formed separately is bonded to the parallel-cross structure made of a metal material, since the parallel-cross structure made of a resin material is embedded in the gap of the parallel-cross structure made of the metal material, it is difficult to realized bonding with welding since deterioration or the like of the resin occurs due to heat. Therefore, the parallel-cross structure and the metallic member have to be bonded by a bonding method other than welding-based bonding such as screw-based coupling, for example, and problems that the structure of a bonding portion becomes complex and it is difficult to obtain a sufficient bonding strength may occur.

With the foregoing in view, an object of at least one embodiment of the present invention is to secure a bonding strength of a bonding member obtained by bonding a metal material and a resin material.

(1) A bonding member according to at least one embodiment of the present invention includes: a metal member including a first base portion made of metal and a first engagement portion made of metal and provided integrally with the first base portion; and a resin member including a second base portion made of resin and a second engagement portion made of resin and provided integrally with the second base portion so as to engage with the first engagement portion, wherein the first engagement portion includes a three-dimensional structure formed by a frame to form a plurality of cavities communicating with each other inside the frame, and the second engagement portion includes a resin filled in the plurality of cavities of the three-dimensional structure.

According to the configuration of (1), the metal member includes the first base portion made of metal and the first engagement portion made of metal and provided integrally with the first base portion. Therefore, by forming the resin member including the second engagement portion made of resin and the second base portion made of resin with respect to the first engagement portion of the metal member, a bonding member in which the first base portion made of metal and the second base portion made of resin are bonded by the first engagement portion and the second engagement portion.

According to the configuration of (1), the plurality of cavities of the first engagement portion and the resin of the second engagement portion filled in the cavities restrict change in the mutual relative positions whereby the bonding strength between the first engagement portion and the second engagement portion can be secured. In this way, it is possible to secure the bonding strength between the metal member and the resin member.

(2) In some embodiments, in the configuration of (1), the first engagement portion has at least one of a recess portion in which an outer shape of the first engagement portion has a depressed shape or a projection portion in which the outer shape has a protruding shape, the second engagement portion engages with the first engagement portion at least in a forming region of the recess portion or a forming region of the projection portion, and the second base portion is connected to the second engagement portion at least in the recess portion or the projection portion.

According to the configuration of (2), since it is easy to increase an engagement region between the first engagement portion and the second engagement portion, it is easy to secure the bonding strength between the metal member and the resin member.

(3) In some embodiments, in the configuration of (2), the first engagement portion has the projection portion, and the projection portion has at least a distal end which is covered by the second base portion.

According to the configuration of (3), it is easy to realize positioning of the relative position between the metal member and the resin member.

(4) In some embodiments, in the configuration of (3), a portion of the first base portion penetrates into the projection portion toward the distal end of the projection portion.

According to the configuration of (4), with the portion of the first base portion penetrating into the projection portion, it is possible to easily reinforce the strength in the projection portion of the first engagement portion.

(5) In some embodiments, in the configuration of any one of (2) to (4), the first engagement portion has the recess portion, and a portion of the second base portion is inserted into the recess portion.

According to the configuration of (5), even if the second base portion is a relatively thin member, for example, a portion inserted into the recess portion can be easily formed in the second base portion. Therefore, even if the second base portion is a relatively thin member, for example, positioning of the relative position between the metal member and the resin member is realized easily.

(6) In some embodiments, in the configuration of any one of (1) to (5), a base end of the first engagement portion penetrates into the recess portion of the first base portion.

According to the configuration of (6), even if it is difficult to provide such a first engagement portion that protrudes from the first base portion toward the second base portion due to restrictions such as the shape or the like of the second base portion, for example, when the first engagement portion is formed in the recess portion of the first base portion, since it is easy to increase an engagement region between the first engagement portion and the second engagement portion, it is easy to secure the bonding strength between the metal member and the resin member.

(7) In some embodiments, in the configuration of any one of (1) to (6), a ratio of the frame per unit volume including the cavity and the frame in the first engagement portion is larger in a region close to the first base portion than in a region close to the second base portion.

For example, when the first base portion and the second base portion are extended in directions away from each other, a frame of the first engagement portion in a region close to the first base portion bears a load acting on a frame in the region close to the first base portion and a load acting on a frame in a region closer to the second base portion than the region. Therefore, from the perspective of the strength of the first engagement portion, a ratio of the frame per unit volume including the frame and the cavity of the first engagement portion is preferably larger in a region close to the first base portion than in a region close to the second base portion.

In this respect, according to the configuration of (7), since the ratio is larger in the region close to the first base portion than in the region close to the second base portion, it is possible to secure the strength of the first engagement portion.

In contrast, according to the configuration of (7), the ratio of the cavity per unit volume including the frame and the cavity in the first engagement portion is larger in a region close to the second base portion than in a region close to the first base portion. Therefore, according to the configuration of (7), the ratio of a resin per unit volume in a region in which the first engagement portion and the second engagement portion engage with each other is larger in a region close to the second base portion than in a region close to the first base portion.

Similarly to the case of the first engagement portion, from the perspective of the strength of the second engagement portion, the ratio of a resin per unit volume in a region in which the first engagement portion and the second engagement portion engage with each other is preferably larger in a region close to the second base portion than in a region close to the first base portion.

In this respect, according to the configuration of (7), since the ratio of a resin per unit volume in a region in which the first engagement portion and the second engagement portion engage with each other is larger in a region close to the second base portion than in a region close to the second base portion, it is possible to secure the strength of the first engagement portion.

(8) In some embodiments, in the configuration of any one of (1) to (7), the first engagement portion has at least a first layer and a second layer stacked on the first layer, and the frame includes at least one first extension portion extending in a first direction in the first layer and at least one second extension portion extending in a second direction intersecting the first direction in the second layer.

According to the configuration of (8), the first extension portion and the second extension portion of the first engagement portion extending in different directions and the resin of the second engagement portion filled in the cavity of the first engagement portion in which the first extension portion and the second extension portion are not located can be mechanically coupled with each other. In this way, it is possible to secure the bonding strength between the metal member and the resin member.

(9) In some embodiments, in the configuration of (8), the first layer is located closer to the first base portion than the second layer, and a ratio of the frame per unit volume in the first layer is larger than a ratio of the frame per unit volume in the second layer.

As described above, when the first base portion and the second base portion are extended in directions away from each other, the first extension portion in the first layer bears a load acting on the first extension portion and a load acting on the second extension portion in the second layer closer to the second base portion than the first extension portion. Therefore, from the perspective of the strength of the first engagement portion, the ratio of the frame per unit volume in the first layer is preferably larger than the ratio of the frame per unit volume in the second layer.

From this respect, according to the configuration of (9), since the ratio of the frame per unit volume in the first layer is larger than the ratio of the frame per unit volume in the second layer, it is possible to secure the strength of the first engagement portion.

In contrast, according to the configuration of (9), the ratio of the cavity per unit volume in the second layer is larger than the ratio of the cavity per unit volume in the first layer. Therefore, according to the configuration of (9), the ratio of a resin per unit volume in a region in which the first engagement portion and the second engagement portion engage with each other is larger in the second layer close to the second base portion than in the first layer close to the first base portion.

Similarly to the case of the first engagement portion, from the perspective of the strength of the second engagement portion, the ratio of a resin per unit volume in a region in which the first engagement portion and the second engagement portion engage with each other is preferably larger in the second layer close to the second base portion than in the first layer close to the first base portion.

In this respect, according to the configuration of (9), since the ratio of a resin per unit volume in a region in which the first engagement portion and the second engagement portion engage with each other is larger in the second layer close to the second base portion than in the first layer close to the first base portion, it is possible to secure the strength of the second engagement portion.

(10) In some embodiments, in the configuration of (9), a cross-sectional area of the first extension portion in a cross-section orthogonal to an extension direction of the first extension portion is larger than a cross-sectional area of the second extension portion in a cross-section orthogonal to an extension direction of the second extension portion.

According to the configuration of (10), since the ratio of a frame per unit volume in the first layer is larger than the ratio of a frame per unit volume in the second layer, it is possible to secure the strength of the first engagement portion. Moreover, according to the configuration of (10), since the ratio of a resin per unit volume in a region in which the first engagement portion and the second engagement portion engage with each other is larger in the second layer close to the second base portion than in the first layer close to the first base portion, it is possible to secure the strength of the second engagement portion.

(11) In some embodiments, in the configuration of (9) or (10), the number of first extension portions is larger than the number of second extension portions.

According to the configuration of (11), since the ratio of a frame per unit volume in the first layer is larger than the ratio of a frame per unit volume in the second layer, it is possible to secure the strength of the first engagement portion. According to the configuration of (11), since the ratio of a resin per unit volume in a region in which the first engagement portion and the second engagement portion engage with each other is larger in the second layer close to the second base portion than in the first layer close to the first base portion, it is possible to secure the strength of the second engagement portion.

(12) In some embodiments, in the configuration of (8), the second layer may be stacked on the first layer in a direction intersecting a direction from the first base portion toward the second base portion.

(13) In some embodiments, in the configuration of any one of (1) to (7), the first engagement portion may include at least a plurality of first shaft-shaped members extending in a first extension direction and a plurality of second shaft-shaped members extending in a second extension direction intersecting the first extension direction, and at least one of the plurality of first shaft-shaped members and at least one of the plurality of second shaft-shaped members may be connected by a connecting portion.

(14) In some embodiments, in the configuration of any one of (1) to (13), a resin constituting the second engagement portion is a resin of the same type as a resin constituting the second base portion.

According to the configuration of (14), for example, a metal member is set on an injection molding die and a resin is injected by an injection molding apparatus whereby the second engagement portion and the second base portion are obtained. In this way, a bonding member in which a metal member and a resin member are bonded is obtained easily.

(15) In some embodiments, in the configuration of any one of (1) to (13), a resin constituting the second engagement portion is a resin of a different type from a resin constituting the second base portion.

According to the configuration of (15), for example, the second base portion formed in advance is bonded with the resin of the second engagement portion whereby a bonding member in which a metal member and a resin member are bonded is obtained. In this case, by using an adhesive as the resin of the second engagement portion, a bonding member in which a metal member and a resin member are bonded is obtained easily.

(16) In some embodiments, in the configuration of (15), a ratio of an area of a metal to an interface at which the second base portion makes contact with the first engagement portion or the second engagement portion is smaller than an average value of the ratio of the frame per unit volume including the cavity and the frame in the first engagement portion.

According to the configuration of (16), the ratio of the area of the resin to an interface at which the second base portion makes contact with the first engagement portion or the second engagement portion is larger than the average value of the ratio of the cavity per unit volume including the cavity and the frame in the first engagement portion. Therefore, when the second base portion formed in advance is bonded using the resin of the second engagement portion as an adhesive, for example, it is possible to increase the area in which the second base portion makes contact with the adhesive filled in the cavity. In this way, it is possible to improve the bonding strength between the second base portion and the second engagement portion.

(17) In some embodiments, the bonding member of the configuration of (16) further includes: a fitting projection portion that protrudes from the second base portion toward the first engagement portion over the interface or protrudes from the first engagement portion toward the second base portion over the interface; and a fitting recess portion formed in the second base portion or the first engagement portion so as to be fitted to the fitting projection portion.

According to the configuration of (17), when the second base portion formed in advance is bonded using the resin of the second engagement portion as an adhesive, for example, by fitting the fitting projection portion and the fitting recess portion together, positioning of the second base portion and the first engagement portion (that is, the metal member) can be realized easily.

(18) In some embodiments, in the configuration of any one of (1) to (17), at least one of the second base portion or the second engagement portion includes fiber in the resin serving as a base material thereof.

According to the configuration of (18), it is possible to improve the strength of the resin member with the fiber.

(19) A bonding member manufacturing method according to at least one embodiment of the present invention includes: filling a resin in a plurality of cavities to form a second engagement portion with respect to a first engagement portion including a three-dimensional structure formed by a frame made of metal and provided integrally with a first base portion made of metal to form the plurality of cavities communicating with each other therein; and obtaining a second base portion made of resin and provided integrally with the second engagement portion.

According to the method of (19), a resin is filled into the plurality of cavities of the first engagement portion provided integrally with the first base portion to form the second engagement portion and to obtain the second base portion made of resin and provided integrally with the second engagement portion whereby a bonding member in which the first base portion made of metal and the second base portion made of resin are bonded is obtained.

(20) In some embodiments, in the method of (19), the resin is filled into the plurality of cavities to form the second engagement portion and the second base portion is formed by the resin.

According to the method of (20), the first base portion and the first engagement portion made of metal and provided integrally are set on an injection molding die and a resin is injected by an injection molding apparatus whereby the second engagement portion and the second base portion are obtained. In this way, a bonding member in which the first base portion made of metal and the second base portion made of resin are bonded is obtained easily.

(21) In some embodiments, in the method of (19), the second base portion and the first engagement portion are attached by the resin filled into the plurality of cavities.

According to the method of (21), a bonding member in which the first base portion and the first engagement portion made of metal and provided integrally by bonding the second base portion formed in advance with the resin in the cavity of the first engagement portion are bonded with the second base portion is obtained. In this case, by using an adhesive as the resin of the second engagement portion, the bonding member is obtained easily.

According to at least one embodiment of the present invention, it is possible to secure a bonding strength of a bonding member obtained by bonding a metal material and a resin material.

### BRIEF DESCRIPTION OF DRAWINGS

FIG. 1 is a schematic perspective view of a bonding member according to some embodiments.

FIG. 2 is a schematic exploded view of a bonding member according to an embodiment.

FIG. 3 is a schematic exploded view of a bonding member according to another embodiment.

FIG. 4 is a schematic perspective view of a bonding member according to still another embodiment.

FIG. 5 is a schematic view for describing a cross-sectional area of a cross-section orthogonal to an extension direction of a first extension portion and a second extension portion of a first engagement portion according to another embodiment.

FIG. 6 is a perspective view schematically illustrating a first engagement portion according to still another embodiment.

FIG. 7 is a schematic view of a first engagement portion for describing an example for decreasing a contact area between a second base portion and the first engagement portion.

FIG. 8 is a schematic view of a first engagement portion for describing another example for decreasing a contact area between a second base portion and the first engagement portion.

FIG. 9 is a diagram for describing an example in which a portion that is fitted to a second base portion and a first engagement portion is provided in a contacting portion of the second base portion and the first engagement portion.

FIG. 10 is a schematic cross-sectional view for describing various examples of the shape of the first engagement portion.

FIG. 11 is a schematic cross-sectional view for describing various examples of the shape of the first engagement portion.

FIG. 12 is a schematic cross-sectional view for describing various examples of the shape of the first engagement portion.

FIG. 13 is a schematic cross-sectional view for describing various examples of the shape of the first engagement portion.

FIG. 14 is a schematic cross-sectional view for describing various examples of the shape of the first engagement portion.

FIG. 15 is a schematic cross-sectional view for describing various examples of the shape of the first engagement portion.

FIG. 16 is a schematic cross-sectional view for describing various examples of the shape of the first engagement portion.

FIG. 17 is a schematic cross-sectional view for describing various examples of the shape of the first engagement portion.

FIG. 18 is a flowchart of a bonding member manufacturing method according to some embodiments.

FIG. 19 is a perspective view illustrating a modification of the first engagement portion.

FIG. 20 is a perspective view illustrating an example of a first engagement portion having a three-dimensional structure rather than a simple parallel-cross structure.

FIG. 21 is a perspective view of a unit grid of a three-dimensional structure in an embodiment illustrated in FIG. 20.

FIG. 22 is a diagram illustrating some examples of the shape of a unit grid.

FIG. 23 is a cross-sectional view of bonding members according to still another embodiment.

FIG. 24 is a graph showing the tensile strength of bonding members according to still another embodiment.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

For example, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

Furthermore, an expression of an equal state such as “same” “equal” and “uniform” shall not be construed as indicating only the state in which the feature is strictly equal, but also includes a state in which there is a tolerance or a difference that can still achieve the same function.

Furthermore, for example, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

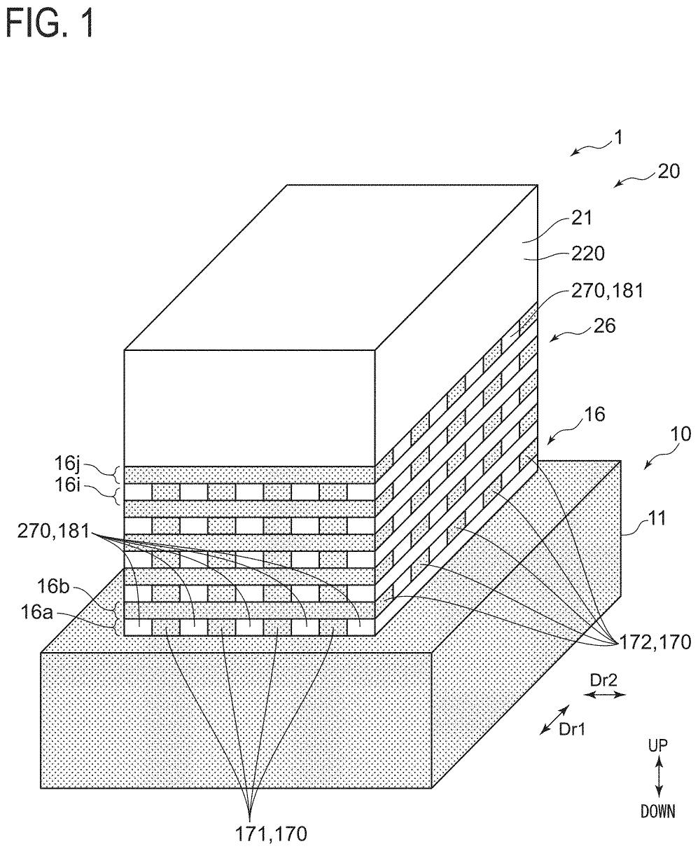

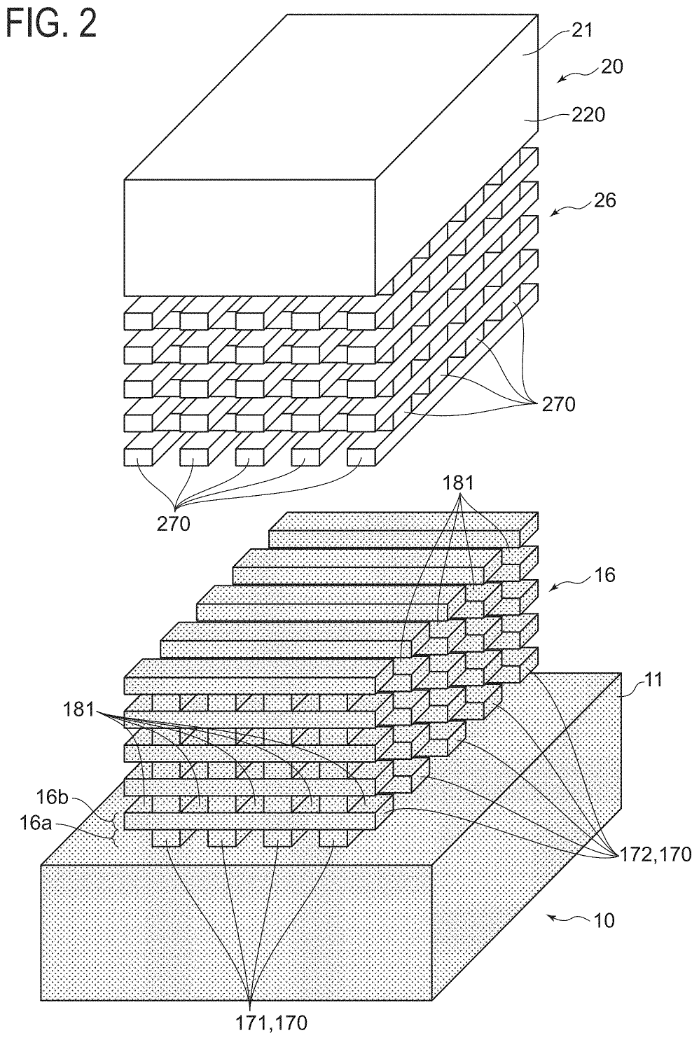

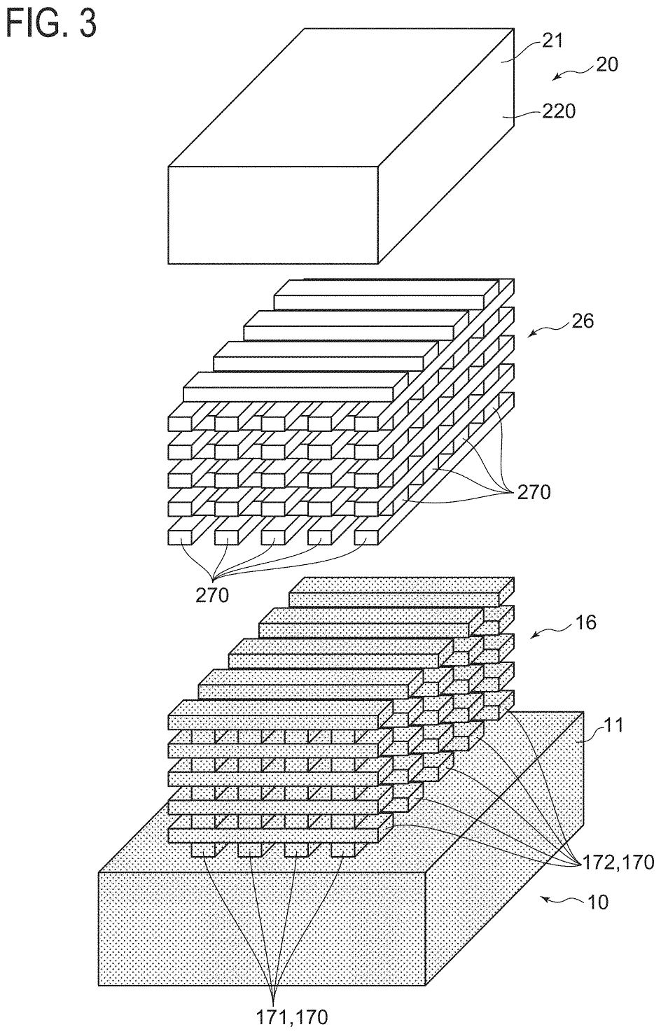

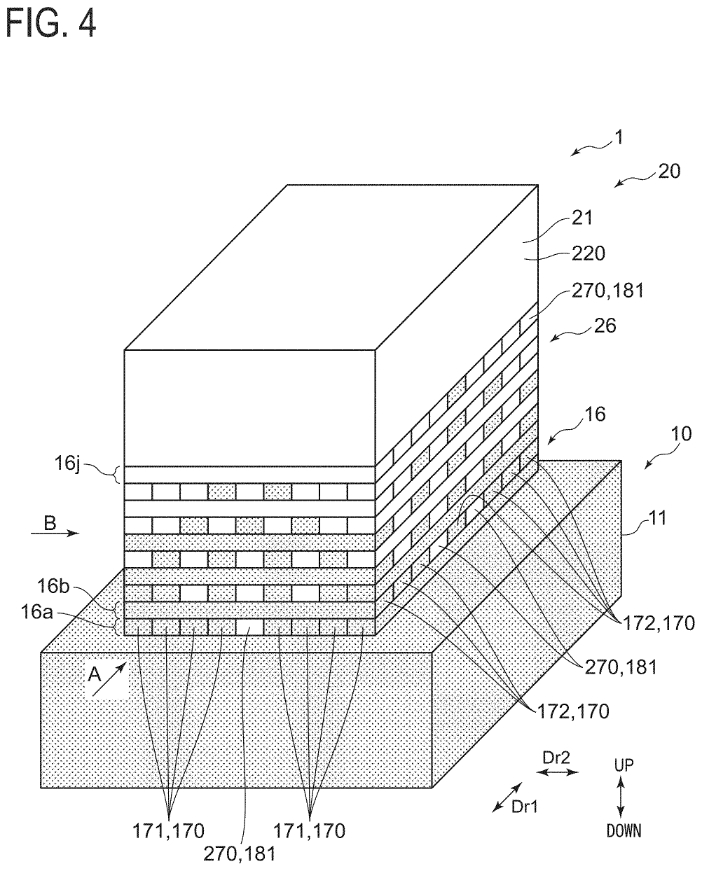

FIG. 1 is a schematic perspective view of a bonding member according to some embodiments. FIG. 2 is a schematic exploded view of a bonding member according to an embodiment. FIG. 3 is a schematic exploded view of a bonding member according to another embodiment. FIG. 4 is a schematic perspective view of a bonding member according to still another embodiment.

A bonding member 1 according to some embodiments illustrated in FIGS. 1 to 4 is a bonding member obtained by bonding a metal member 10 and a resin member 20. That is, the bonding member 1 according to some embodiments illustrated in FIGS. 1 to 4 is a composite member of a metal and a resin.

The metal member 10 according to some embodiments illustrated in FIGS. 1 to 4 includes a first base portion 11 made of metal and a first engagement portion 16 made of metal and provided integrally with the first base portion 11.

The resin member 20 according to some embodiments illustrated in FIGS. 1 to 4 includes a second base portion 21 made of resin and a second engagement portion 26 made of resin and provided integrally with the second base portion 21 so as to engage with the first engagement portion 16.

In FIGS. 2 and 3, the second engagement portion 26 engaging with the first engagement portion 16 of the bonding member 1 according to some embodiments is depicted separately from the first engagement portion 16 for convenience of explanation.

Hereinafter, the first engagement portion 16 of the bonding member 1 according to some embodiments illustrated in FIGS. 1 to 4 will be described. In the bonding member 1 according to some embodiments, the resin of the second engagement portion 26 is filled into cavities 181 (to be described later) of the first engagement portion 16. Therefore, in the following description of the bonding member 1, a state in which the resin of the second engagement portion 26 is not filled into the cavities 181 is assumed when describing the structure of the first engagement portion 16 only rather than a state in which the metal member 10 and the resin member 20 are bonded.

In the bonding member 1 according to some embodiments illustrated in FIGS. 1 to 4, the first engagement portion 16 includes a three-dimensional structure formed by a frame 170 made of metal to form a plurality of cavities 181 communicating with each other inside the frame 170. In the bonding member 1 according to some embodiments illustrated in FIGS. 1 to 4, the first engagement portion 16 has at least a first layer 16a and a second layer 16b stacked on the first layer 16a. In the bonding member 1 according to some embodiments illustrated in FIGS. 1 to 4, the frame 170 includes at least one first extension portion 171 extending in a first direction Dr1 in the first layer 16a and at least one second extension portion 172 extending in a second direction Dr2 intersecting the first direction Dr1 in the second layer 16b.

In the bonding member 1 according to some embodiments illustrated in FIGS. 1 to 4, the first direction Dr1 and the second direction Dr2 are orthogonal to each other, for example.

In the bonding member 1 according to some embodiments illustrated in FIGS. 1 to 4, for convenience of explanation, it is assumed that the first engagement portion 16 has a 10-layer structure, for example, and includes a first layer 16a to a tenth layer 16j, for example.

In the bonding member 1 according to some embodiments illustrated in FIGS. 1 to 3, among the first layer 16a to the tenth layer 16j, for example, odd-numbered layers have a configuration similar to the first layer 16a and even-numbered layers have a configuration similar to the second layer 16b. That is, in the bonding member 1 according to some embodiments illustrated in FIGS. 1 to 3, it can be said that the first engagement portion 16 has a configuration in which the first layer 16a and the second layer 16b are stacked alternately and repeatedly.

For convenience of explanation, a stacking direction of respective layers of the first layer 16a to the tenth layer 16j is sometimes referred to simply as a stacking direction or a height direction, and an upward direction illustrated in FIGS. 1 to 4 of the stacking direction is defined as an upper side and a downward direction illustrated in FIGS. 1 to 4 is defined as a lower side.

In the bonding member 1 according to some embodiments illustrated in FIGS. 1 to 3, the first layer 16a includes four first extension portions 171, for example, and the respective first extension portions 171 are arranged in a state of being separated from the adjacent first extension portions 171 in a direction (that is, the second direction Dr2) orthogonal to the first direction Dr1.

In the bonding member 1 according to some embodiments illustrated in FIGS. 1 to 3, the second layer 16b includes five second extension portions 172, for example, and the respective second extension portions 172 are arranged in a state of being separated from the adjacent second extension portions 172 in a direction (that is, the first direction Dr1) orthogonal to the second direction Dr2.

In the bonding member 1 according to some embodiments illustrated in FIGS. 1 to 3, a region of the first layer 16a in which the first extension portion 171 is not located and a region of the second layer 16b in which the second extension portion 172 is not located are the cavity 181 formed by the first extension portion 171 and the second extension portion 172.

In the bonding member 1 according to an embodiment illustrated in FIG. 4, in the respective layers of the first layer 16a to the tenth layer 16j, the number of first extension portions 171 or second extension portions 172 decreases as it departs from the first base portion 11. That is, in the bonding member 1 according to an embodiment illustrated in FIG. 4, the ratio of the frame 170 per unit volume in the first engagement portion 16 decreases as it departs from the first base portion 11.

The bonding member 1 according to some embodiments illustrated in FIGS. 1 to 4 has a parallel-cross structure formed by the first extension portion 171 and the second extension portion 172 intersecting each other. In the bonding member 1 according to some embodiments illustrated in FIGS. 1 to 4, the cavity 181 has a parallel-cross shape.

In the bonding member 1 according to some embodiments illustrated in FIGS. 1 to 4, the first extension portion 171 and the second extension portion 172 making contact with each other in the stacking direction are actually provided integrally and are bonded together.

In the bonding member 1 according to some embodiments illustrated in FIGS. 1 to 4, the first engagement portion 16 can be formed on the first base portion 11 according to additive manufacturing, for example. A method for forming the first engagement portion 16 according to some embodiments illustrated in FIGS. 1 to 4 may be powder bed fusion, metal deposition, or binder jetting, for example, and may be a method other than the above-mentioned methods.

The first base portion 11 according to some embodiments illustrated in FIGS. 1 to 4 may be formed according to additive manufacturing similarly to the first engagement portion 16 and may be formed by casting, forging, cutting, powder sintering, or the like.

In the bonding member 1 according to some embodiments illustrated in FIGS. 1 to 4, the second engagement portion 26 includes a resin 270 filled into the plurality of cavities 181 of the three-dimensional structure. That is, in the bonding member 1 according to some embodiments illustrated in FIGS. 1 to 4, the second engagement portion 26 has the same parallel-cross shape as the cavity 181.

In an embodiment illustrated in FIG. 2, the second engagement portion 26 is formed simultaneously with the second base portion 21, for example, and is integrated with the second base portion 21. In an embodiment illustrated in FIG. 2, the resin 270 constituting the second engagement portion 26 is the same resin as a resin 220 constituting the second base portion 21.

Therefore, in an embodiment illustrated in FIG. 2, for example, the metal member 10 is set on an injection molding die and a resin is injected by an injection molding apparatus whereby the second engagement portion 26 and the second base portion 21 are obtained. In this way, the bonding member 1 in which the metal member 10 and the resin member 20 are bonded is obtained easily.

In an embodiment illustrated in FIG. 3, the second engagement portion 26 is integrated with the second base portion 21 by forming the second engagement portion 26 with respect to the second base portion 21 formed in advance, for example. That is, in an embodiment illustrated in FIG. 3, the resin 270 constituting the second engagement portion 26, for example, is attached to the second engagement portion 26 using the second base portion 21 formed in advance as an adhesive whereby the bonding member 1 in which the metal member 10 and the resin member 20 are bonded is obtained.

In an embodiment illustrated in FIG. 3, the resin 270 constituting the second engagement portion 26 may be a resin of the same type as or a different type from the resin 220 constituting the second base portion 21.

As described above, in the bonding member 1 according to some embodiments illustrated in FIGS. 1 to 4, the metal member 10 includes the first base portion 11 made of metal and the first engagement portion 16 made of metal and provided integrally with the first base portion 11. Therefore, when the resin member 20 including the second engagement portion 26 made of resin and the second base portion 21 made of resin is formed with respect to the first engagement portion 16 of the metal member 10, the bonding member 1 in which the first base portion 11 made of metal and the second base portion 21 made of resin are bonded by the first engagement portion 16 and the second engagement portion 26 is obtained.

In the bonding member 1 according to some embodiments illustrated in FIGS. 1 to 4, the plurality of cavities 181 of the first engagement portion 16 and the resin 270 of the second engagement portion 26 filled in the cavity 181 restrict change in the mutual relative positions whereby the bonding strength between the first engagement portion 16 and the second engagement portion 26 can be secured. In this way, it is possible to secure the bonding strength between the metal member 10 and the resin member 20.

That is, in the bonding member 1 according to some embodiments illustrated in FIGS. 1 to 4, at least a portion of the frame 170 and at least a portion of the resin in the cavity 181 are configured to press each other when it is tried to change the relative positions between the first base portion 11 and the second base portion 21. Therefore, in the bonding member 1 according to some embodiments illustrated in FIGS. 1 to 4, since the first base portion 11 made of metal and the second base portion 21 made of resin are mechanically coupled by the first engagement portion 16 and the second engagement portion 26, it is possible to secure the bonding strength between the metal member 10 and the resin member 20.

In the bonding member 1 according to some embodiments illustrated in FIGS. 1 to 4, mechanical coupling is realized by the first extension portion 171 and the second extension portion 172 of the first engagement portion 16 extending in different directions and the resin 270 of the second engagement portion 26 filled in the cavities 181 in which the first extension portion 171 and the second extension portion 172 of the first engagement portion 16 are not located. In this way, it is possible to secure the bonding strength between the metal member 10 and the resin member 20.

As described above, in the bonding member 1 according to an embodiment illustrated in FIG. 4, in the respective layers of the first layer 16a to the tenth layer 16j, the number of first extension portions 171 or second extension portions 172 decreases as it departs from the first base portion 11. In other words, in the bonding member 1 according to an embodiment illustrated in FIG. 4, in the respective layers of the first layer 16a to the tenth layer 16j, the number of first extension portions 171 or second extension portions 172 increases as it approaches the first base portion 11. That is, in the bonding member 1 according to an embodiment illustrated in FIG. 4, the ratio of the frame 170 per unit volume including the frame 170 and the cavity 181 of the first engagement portion 16 is larger in a region close to the first base portion 11 than in a region close to the second base portion 21. In the bonding member 1 according to an embodiment illustrated in FIG. 4, the ratio of the frame 170 per unit volume in the first layer 16a, for example, is larger than the ratio of the frame 170 per unit volume in the second layer 16b. Specifically, in the bonding member 1 according to an embodiment illustrated in FIG. 4, the number of first extension portions 171 of the first layer 16a, for example, is larger than the number of second extension portions 172 of the second layer 16b.

For example, when the first base portion 11 and the second base portion 21 are extended in directions away from each other, the frame 170 of the first engagement portion 16 in a region close to the first base portion 11 bears a load acting on the frame 170 in the region and a load acting on the frame 170 in a region closer to the second base portion 21 than the region. Therefore, from the perspective of the strength of the first engagement portion 16, the ratio of the frame 170 per unit volume including the frame 170 and the cavity 181 in the first engagement portion 16 is preferably larger in a region close to the first base portion 11 than in a region close to the second base portion 21.

In this respect, in the bonding member 1 according to an embodiment illustrated in FIG. 4, since the ratio of the frame 170 per unit volume including the frame 170 and the cavity 181 in the first engagement portion 16 is larger in a region close to the first base portion 11 than in a region close to the second base portion 21, it is possible to secure the strength of the first engagement portion 16.

In contrast, in the bonding member 1 according to an embodiment illustrated in FIG. 4, the ratio of the cavity 181 per unit volume including the frame 170 and the cavity 181 in the first engagement portion 16 is larger in a region close to the second base portion 21 than in a region close to the first base portion 11. Therefore, in the bonding member 1 according to an embodiment illustrated in FIG. 4, the ratio of the resin 270 per unit volume in a region in which the first engagement portion 16 and the second engagement portion 26 engage with each other is larger in a region close to the second base portion 21 than in a region close to the first base portion 11.

Similarly to the case of the first engagement portion 16, from the perspective of the strength of the second engagement portion 26, the ratio of the resin 270 per unit volume in a region in which the first engagement portion 16 and the second engagement portion 26 engage with each other is preferably larger in a region close to the second base portion 21 than in a region close to the first base portion 11.

In this respect, in the bonding member 1 according to an embodiment illustrated in FIG. 4, since the ratio of the resin 270 per unit volume in a region in which the first engagement portion 16 and the second engagement portion 26 engage with each other is larger in a region close to the second base portion 21 than in a region close to the first base portion 11, it is possible to secure the strength of the second engagement portion 26.

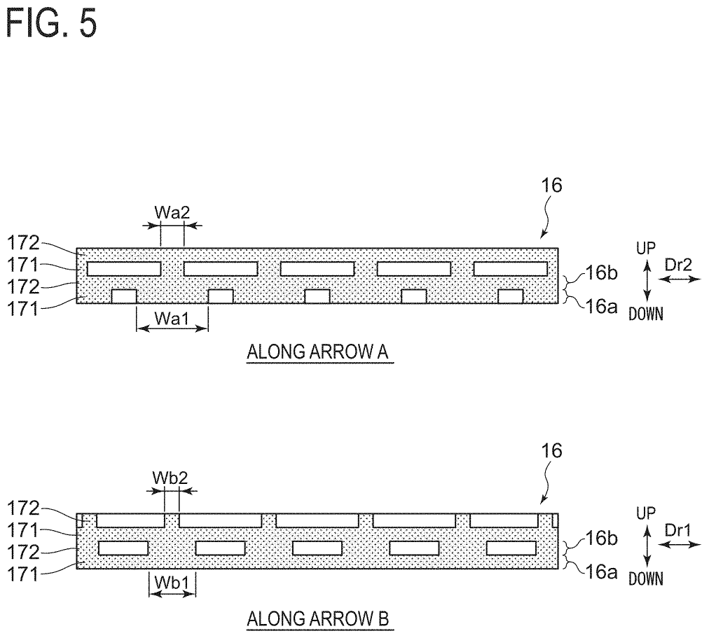

As illustrated in FIG. 5, for example, a cross-sectional area of a cross-section orthogonal to an extension direction of the first extension portion 171 or the second extension portion 172 may increase as it approaches the first base portion 11 (that is, as it approaches the downward side in FIG. 5). FIG. 5 is a schematic view for describing a cross-sectional area of a cross-section orthogonal to the extension direction of the first extension portion 171 and the second extension portion 172 of the first engagement portion 16 according to another embodiment. FIG. 5 illustrates a view along arrow A in FIG. 4 when the first engagement portion 16 according to another embodiment having a configuration similar to the first engagement portion 16 according to an embodiment illustrated in FIG. 4 is seen along the extension direction of the first extension portion 171 and a view along arrow B in FIG. 4 when the first engagement portion 16 is seen along the extension direction of the second extension portion 172. FIG. 5 is a diagram for describing the cross-sectional area of the first extension portion 171 and the second extension portion 172 of the first engagement portion 16 according to another embodiment, and the shape, the number, and the like are not identical to those of the first extension portions 171 and the second extension portions 172 of the first engagement portion 16 according to an embodiment illustrated in FIG. 4.

For example, in another embodiment illustrated in FIG. 5, although a case in which the dimensions in the up-down direction of the first extension portion 171 and the second extension portion 172 are equal to each other will be described, the dimensions in the up-down direction may be different within the meaning of the following description.

For example, in another embodiment illustrated in FIG. 5, the widths Wa1 and Wa2 in the second direction Dr2 of the first extension portion 171 increase as it approaches the first base portion 11. Moreover, in another embodiment illustrated in FIG. 5, the widths Wb1 and Wb2 in the first direction Dr1 of the second extension portion 172 increase as it approaches the first base portion 11.

In another embodiment illustrated in FIG. 5, the width Wa1 in the second direction Dr2 of the first extension portion 171 of the first layer 16a is larger than the width Wb1 in the first direction Dr1 of the second extension portion 172 of the second layer 16b. That is, in another embodiment illustrated in FIG. 5, a cross-sectional area of the first extension portion 171 in the cross-section orthogonal to the extension direction of the first extension portion 171 of the first layer 16a is larger than the cross-sectional area of the second extension portion 172 in the cross-section orthogonal to the extension direction of the second extension portion 172 of the second layer 16b.

For example, as illustrated in FIG. 5, even when the cross-sectional area of the first extension portion 171 or the second extension portion 172 in the cross-section orthogonal to the extension direction of the first extension portion 171 or the second extension portion 172 is increased as it approaches the first base portion 11, since the ratio of the frame 170 per unit volume including the frame 170 and the cavity 181 of the first engagement portion 16 is larger in the region close to the first base portion 11 than in the region close to the second base portion 21, it is possible to secure the strength of the first engagement portion 16.

Instead of increasing the number of first extension portions 171 or second extension portions 172 as it approaches the first base portion 11 like the first engagement portion 16 of an embodiment illustrated in FIG. 4 as described above, the cross-sectional area of the first extension portion 171 or the second extension portion 172 in the cross-section orthogonal to the extension direction of the first extension portion 171 or the second extension portion 172 may be increased as it approaches the first base portion 11 as illustrated in FIG. 5. Moreover, the number of first extension portions 171 or second extension portions 172 may be increased as it approaches the first base portion 11 like the first engagement portion 16 of an embodiment illustrated in FIG. 4 as described above, and the cross-sectional area of the first extension portion 171 or the second extension portion 172 in the cross-section orthogonal to the extension direction of the first extension portion 171 or the second extension portion 172 may be increased as it approach the first base portion 11 as illustrated in FIG. 5.

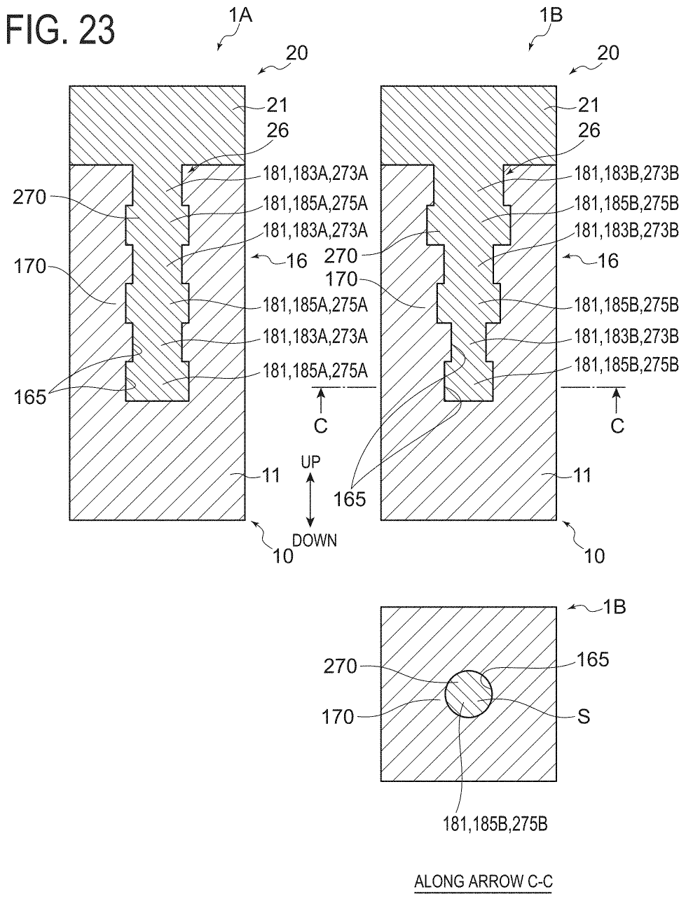

FIG. 23 is a cross-sectional view of bonding members 1A, 1B according to still another embodiment. For example, as shown in FIG. 23, the bonding member 1A according to still another embodiment is formed so that the cavity 181 of the first engagement portion 16 includes a large-diameter portion 185A and a small-diameter portion 183A having a smaller diameter than the large-diameter portion 185A. The bonding member 1B according to still another embodiment is formed so that the cavity 181 of the first engagement portion 16 includes a large-diameter portion 185B and a small-diameter portion 183B having a smaller diameter than the large-diameter portion 185B.

In the bonding member 1A, 1B shown in FIG. 23, the small-diameter portion 183A, 183B and the large-diameter portion 185A, 185B have a circular cylindrical shape extending in the up-down direction. However, the small-diameter portion 183A, 183B and the large-diameter portion 185A, 185B may have an elliptical cylindrical shape or a polygonal prism shape.

In other words, the first engagement portion 16 of the bonding member 1A, 1B shown in FIG. 23 has a pillar-shaped inner circumferential wall surface 165. The inner circumferential wall surface 165 extends along a direction from the first base portion 11 toward the second base portion 21 (up-down direction) and surrounds the cavity 181.

In a cross-section orthogonal to the direction from the first base portion 11 toward the second base portion 21 (i.e., up-down direction), the cross-sectional area of a region surrounded by the inner circumferential wall surface 165 is called cross-sectional area S. In the bonding member 1A shown in FIG. 23, the cross-sectional area S of the small-diameter portion 183A is smaller than the cross-sectional area S of the large-diameter portion 185A. Further, in the bonding member 1B shown in FIG. 23, when comparing one small-diameter portion 183B and a large-diameter portion 185B disposed below and adjacent to the small-diameter portion 183B, the cross-sectional area S of the small-diameter portion 183B is smaller than the cross-sectional area S of the large-diameter portion 185B.

In the first engagement portion 16 of the bonding member 1A, 1B shown in FIG. 23, the small-diameter portion 183A, 183B is alternated with the large-diameter portion 185A, 185B along the up-down direction, for example. When a combination of one small-diameter portion 183A, 183B and a large-diameter portion 185A, 185B disposed below and adjacent to the small-diameter portion 183A, 183B is considered as one stage (one pair), the first engagement portion 16 includes, for example, three stages (three pairs) of the small-diameter portion 183A, 183B and the large-diameter portion 185A, 185B.

In the bonding member 1A shown in FIG. 23, the diameter of the small-diameter portion 183A is the same between pairs, and the diameter of the large-diameter portion 185A is the same between pairs.

Accordingly, in the bonding member 1A shown in FIG. 23, when comparing small-diameter portions 183A in different pairs, in a cross-section orthogonal to the up-down direction, the ratio of the frame 170 per unit area including the frame 170 and the cavity 181 of the first engagement portion 16 is constant regardless of the distance from the first base portion 11.

Similarly, in the bonding member 1A shown in FIG. 23, when comparing large-diameter portions 185A in different pairs, in a cross-section orthogonal to the up-down direction, the ratio of the frame 170 per unit area including the frame 170 and the cavity 181 of the first engagement portion 16 is constant regardless of the distance from the first base portion 11.

In the bonding member 1B shown in FIG. 23, the small-diameter portion 183B in a lower pair has a smaller diameter, and the large-diameter portion 185B in a lower pair has a smaller diameter. Incidentally, the diameter of the small-diameter portion 183B in the lowest pair of the bonding member 1B shown in FIG. 23 is smaller than the diameter of the small-diameter portion 183A of the bonding member 1A shown in FIG. 23. The diameter of the small-diameter portion 183B in the middle pair, with respect to the up-down direction, of the bonding member 1B shown in FIG. 23 is the same as the diameter of the small-diameter portion 183A of the bonding member 1A shown in FIG. 23. The diameter of the small-diameter portion 183B in the uppermost pair of the bonding member 1B shown in FIG. 23 is larger than the diameter of the small-diameter portion 183A of the bonding member 1A shown in FIG. 23.

Accordingly, in the bonding member 1B shown in FIG. 23, when comparing small-diameter portions 183B in different pairs, in a cross-section orthogonal to the up-down direction, the ratio of the frame 170 per unit area including the frame 170 and the cavity 181 of the first engagement portion 16 is larger in a pair close to the first base portion 11 than in a pair close to the second base portion 21. Similarly, in the bonding member 1B shown in FIG. 23, when comparing large-diameter portions 185B in different pairs, in a cross-section orthogonal to the up-down direction, the ratio of the frame 170 per unit area including the frame 170 and the cavity 181 of the first engagement portion 16 is larger in a pair close to the first base portion 11 than in a pair close to the second base portion 21.

Thus, in the bonding member 1B shown in FIG. 23, the cross-sectional area of the first engagement portion 16 in a cross-section orthogonal to the up-down direction gradually increases downward, i.e., toward the first base portion 11, while fluctuating. In the bonding member 1B shown in FIG. 23, the cross-sectional area S of a region surrounded by the inner circumferential wall surface 165 in a cross-section orthogonal to the direction from the first base portion 11 toward the second base portion 21 (up-down direction) gradually decreases toward the first base portion 11 while fluctuating.

In the bonding member 1A shown in FIG. 23, the second engagement portion 26 includes a small-diameter portion 273A made of the resin 270 filled in the small-diameter portion 183A and a large-diameter portion 275A made of the resin 270 filled in the large-diameter portion 185A. Similarly, in the bonding member 1B shown in FIG. 23, the second engagement portion 26 includes a small-diameter portion 273B made of the resin 270 filled in the small-diameter portion 183B and a large-diameter portion 275B made of the resin 270 filled in the large-diameter portion 185B.

In the second engagement portion 26 of the bonding member 1A, 1B shown in FIG. 23, the small-diameter portion 273A, 273B is alternated with the large-diameter portion 275A, 275B along the up-down direction, for example. When a combination of one small-diameter portion 273A, 273B and a large-diameter portion 275A, 275B disposed below and adjacent to the small-diameter portion 273A, 273B is considered as one stage (one pair), the second engagement portion 26 includes, for example, three stages (three pairs) of the small-diameter portion 273A, 273B and the large-diameter portion 275A, 275B.

In the bonding member 1A shown in FIG. 23, the diameter of the small-diameter portion 273A is the same between pairs, and the diameter of the large-diameter portion 275A is the same between pairs. In the bonding member 1B shown in FIG. 23, the small-diameter portion 273B in a lower pair has a smaller diameter, and the large-diameter portion 275B in a lower pair has a smaller diameter.

In the bonding member 1B shown in FIG. 23, the cross-sectional area of the second engagement portion 26 in a cross section orthogonal to the up-down direction gradually increases upward, i.e., toward the second base portion 21, while fluctuating.

In the first engagement portion 16 of the bonding member 1B shown in FIG. 23, when the first base portion 11 and the second base portion 21 are extended in directions away from each other, a radially outer region of one small-diameter portion 183B bears a tensile load acting on itself and a tensile load acting on a radially outer region of another small-diameter portion 183B farther away from the first base portion 11. Therefore, from the perspective of the strength of the first engagement portion 16, the cross-sectional area of the radially outer region of the small-diameter portion 183B in a cross-section orthogonal to the height direction is preferably larger as it is closer to the first base portion 11.

Further, in the second engagement portion 26 of the bonding member 1B shown in FIG. 23, when the first base portion 11 and the second base portion 21 are extended in directions away from each other, one small-diameter portion 273B bears a tensile load acting on itself and a tensile load acting on another small-diameter portion 273B farther away from the second base portion 21. Therefore, from the perspective of the strength of the second engagement portion 26, the cross-sectional area (cross-sectional area S) of the small-diameter portion 273B in a cross-section orthogonal to the height direction is preferably larger as it is closer to the second base portion 21.

In this respect, in the bonding member 1B shown in FIG. 23, since the cross-sectional area of the radially outer region of the small-diameter portion 183B in a cross-section orthogonal to the height direction, i.e., the cross-sectional area of the frame 170 in a cross-section orthogonal to the height direction, gradually increases toward the first base portion 11 while fluctuating, it is possible to improve the strength of the first engagement portion 16, compared with the bonding member 1A according to another embodiment, and it is possible to secure the bonding strength between the metal member 10 and the resin member 20.

Similarly, in the bonding member 1B shown in FIG. 23, since the cross-sectional area (cross-sectional area S) of the second engagement portion 26 gradually increases toward the second base portion 21 while fluctuating, it is possible to improve the strength of the second engagement portion 26, compared with the bonding member 1A according to another embodiment, and it is possible to secure the bonding strength between the metal member 10 and the resin member 20.

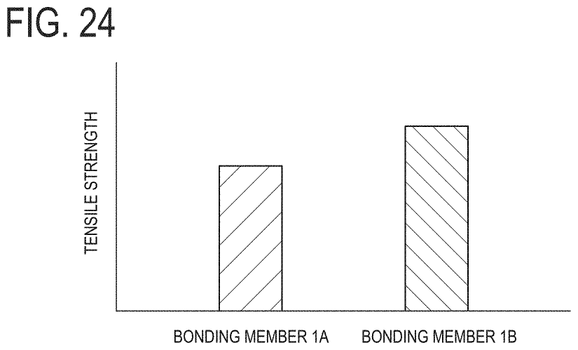

FIG. 24 is a graph showing the tensile strength of the bonding member 1A and the bonding member 1B according to the embodiments shown in FIG. 23. As shown in FIG. 24, the tensile strength of the bonding member 1B shown in FIG. 23 is higher than the tensile strength of the bonding member 1A shown in FIG. 23.

In the embodiment shown in FIG. 4, the cross-sectional area of the first engagement portion 16 in a cross section orthogonal to the up-down direction may increase gradually toward the first base portion 11 while fluctuating. More specifically, for example, among the first layer 16a to the tenth layer 16j, the cross-sectional area of an odd-numbered layer (e.g., ninth layer 16i) under and adjacent an even-numbered layer (e.g., tenth layer 16j) in a cross section orthogonal to the up-down direction may be smaller than the cross-sectional area of the even-numbered layer (e.g., tenth layer 16j) in the cross section orthogonal to the up-down direction. Further, the first engagement portion 16 may be configured so that, when comparing even-numbered layers, an even-numbered layer closer to the first base portion 11 has a larger cross-sectional area in a cross-section orthogonal to the up-down direction. Further, the first engagement portion 16 may be configured so that, when comparing odd-numbered layers, an odd-numbered layer closer to the first base portion 11 has a larger cross-sectional area in a cross-section orthogonal to the up-down direction.

That is, in the embodiment shown in FIG. 4, the ratio of the frame 170 per volume unit including the frame 170 and the cavity 181 of the first engagement portion 16 may gradually increase toward the first base portion 11 while fluctuating.

(Injection of Resin 270)

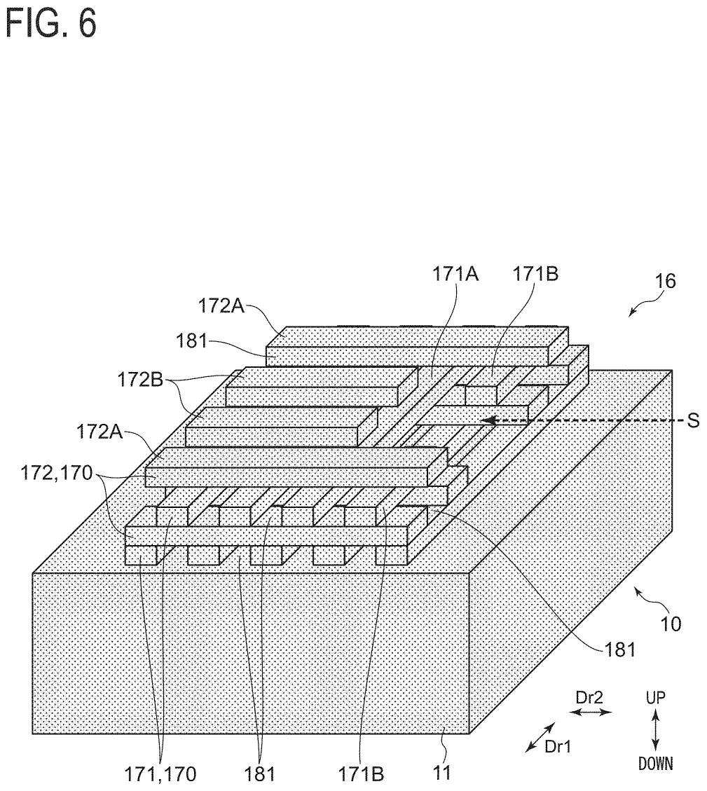

FIG. 6 is a perspective view schematically illustrating the first engagement portion 16 according to still another embodiment.

As described above, the resin 270 may be filled into the cavity 181 of the first engagement portion 16 by injection molding. In this case, the resin 270 may be supplied from a side (for example, from the second direction) indicated by broken-line arrow S in FIG. 6 rather than an upper side of the first engagement portion 16, for example.

In such a case, in order to reliably supply the resin 270 to the cavity 181 in a left-side region in FIG. 6 which is a region distant from an injection position of the resin 270, a structure in which the resin 270 flows easily in a region close to the injection position of the resin 270 is preferable. That is, for example, as illustrated in FIG. 6, the size of the cavity 181 in the region close to the injection position of the resin 270 is preferably larger than the size of the cavity 181 in the region distance from the injection position of the resin 270.

As in still another embodiment illustrated in FIG. 6, for example, the size of the cavity 181 may be increased by notching at least a portion of at least one of the first extension portion 171 and the second extension portion 172 in the region close to the injection position of the resin 270. For example, in still another embodiment illustrated in FIG. 6, the first extension portion 171B in the region close to the injection position of the resin 270 among the plurality of first extension portions 171 has such a shape that the first extension portion 171A in another region is notched halfway. Moreover, for example, in still another embodiment illustrated in FIG. 6, the second extension portion 172B in the region close to the injection position of the resin 270 among the plurality of second extension portions 172 has a shorter length than the second extension portion 172A in another region.

In this way, by forming the cavity 181 in the region close to the injection position of the resin 270 in a larger size than the cavity 181 in the region distant from the injection position of the resin 270, it is possible to easily supply the resin 270 to the region distant from the injection position of the resin 270.

(Adhesion of Resin 270 and Second Base Portion 21)

As described above, in an embodiment illustrated in FIG. 3, the second base portion 21 formed in advance is attached to the second engagement portion 26 using the resin 270 constituting the second engagement portion 26 as an adhesive, for example, whereby the bonding member 1 in which the metal member 10 and the resin member 20 are bonded is obtained. In this case, from the perspective of the adhesion strength between the second base portion 21 and the second engagement portion 26, a large contact area between the second base portion 21 and the second engagement portion 26 (the resin 270) is preferable.

For example, when it is necessary to bring the second base portion 21 into contact with the first engagement portion 16 in the course of attaching the second base portion 21 to the second engagement portion 26, if the contact area between the second base portion 21 and the first engagement portion 16 increases, the contact area between the second base portion 21 and the resin 270 decreases. Therefore, it is preferable to decrease the contact area between the second base portion 21 and the first engagement portion 16.

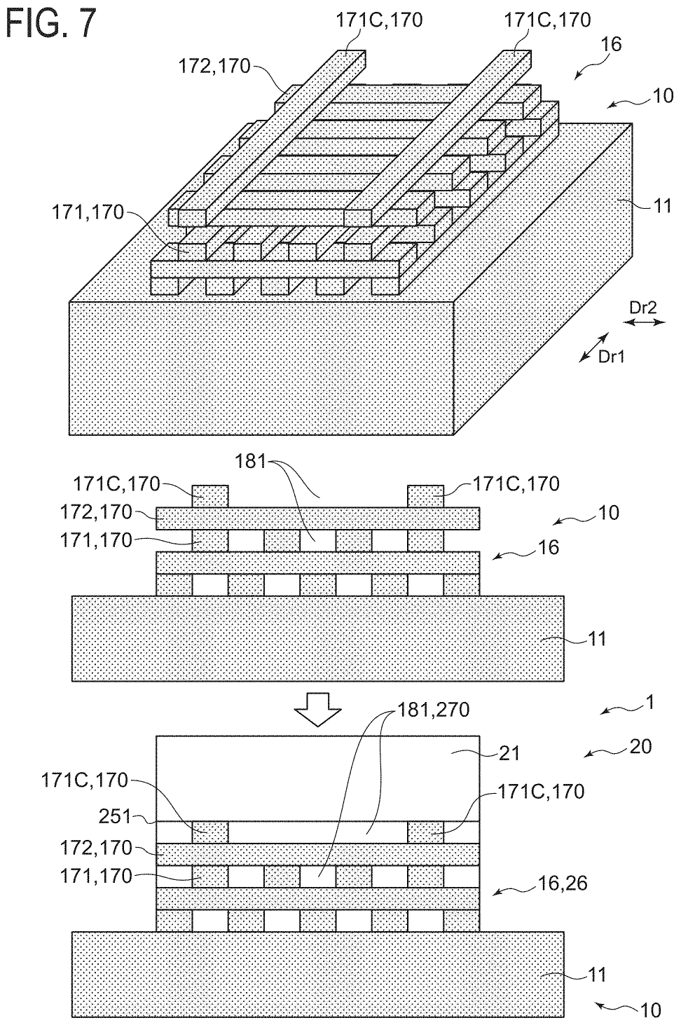

Therefore, as illustrated in FIG. 7, the number of first extension portions 171C which are the frame 170 closest to the second base portion 21, which makes contact with the second base portion 21 in the course of attaching the second base portion 21 to the second engagement portion 26 may be decreased to be smaller than the number of first extension portions 171 positioned closer to the first base portion 11 than the first extension portion 171C. FIG. 7 is a schematic view of the first engagement portion 16 for describing an example for decreasing the contact area between the second base portion 21 and the first engagement portion 16. FIG. 7 illustrates a schematic perspective view of the first engagement portion 16, a schematic front view of the first engagement portion 16, and a schematic front view of the bonding member 1 after the second base portion 21 and the second engagement portion 26 are attached together sequentially in that order from top to bottom.

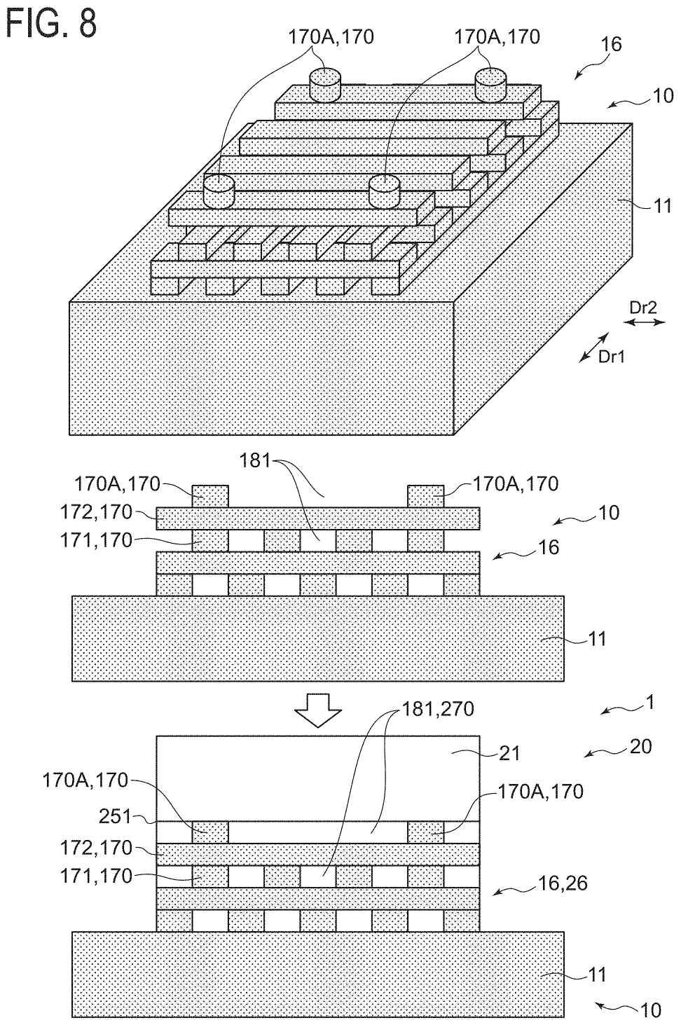

For example, as illustrated in FIG. 8, the area of a contact surface in which the frame 170A makes contact with the second base portion 21 may be decreased by decreasing the size in at least one of the first direction Dr1 and the second direction Dr2 of the frame 170A closest to the second base portion 21 and which makes contact with the second base portion 21 in the course of attaching the second base portion 21 to the second engagement portion 26. FIG. 8 is a schematic diagram of the first engagement portion 16 for describing another example for decreasing the contact area between the second base portion 21 and the first engagement portion 16. FIG. 8 illustrates a schematic perspective view of the first engagement portion 16, a schematic front view of the first engagement portion 16, and a schematic front view of the bonding member 1 after the second base portion 21 and the second engagement portion 26 are attached together sequentially in that order from top to bottom.

As illustrated in FIGS. 7 and 8, the ratio of the area of metal (the frame 170) to an interface 251 at which the first engagement portion 16 or the second engagement portion 26 makes contact with the second base portion 21 is smaller than an average value of the ratio of the frame per unit volume including the frame 170 and the cavity 181 of the first engagement portion 16.

Therefore, the ratio of the area of the resin 270 in the interface 251 at which the first engagement portion 16 or the second engagement portion 26 makes contact with the second base portion 21 is larger than an average value of the ratio of the cavity 181 per unit volume including the frame 170 and the cavity 181 of the first engagement portion 16. Therefore, when the second base portion 21 formed in advance, for example, is bonded using the resin 270 of the second engagement portion 26 as an adhesive, it is possible to increase the area in which the second base portion 21 makes contact with the adhesive (the resin 270) filled in the cavity 181. In this way, it is possible to increase the bonding strength between the second base portion 21 and the second engagement portion 26.

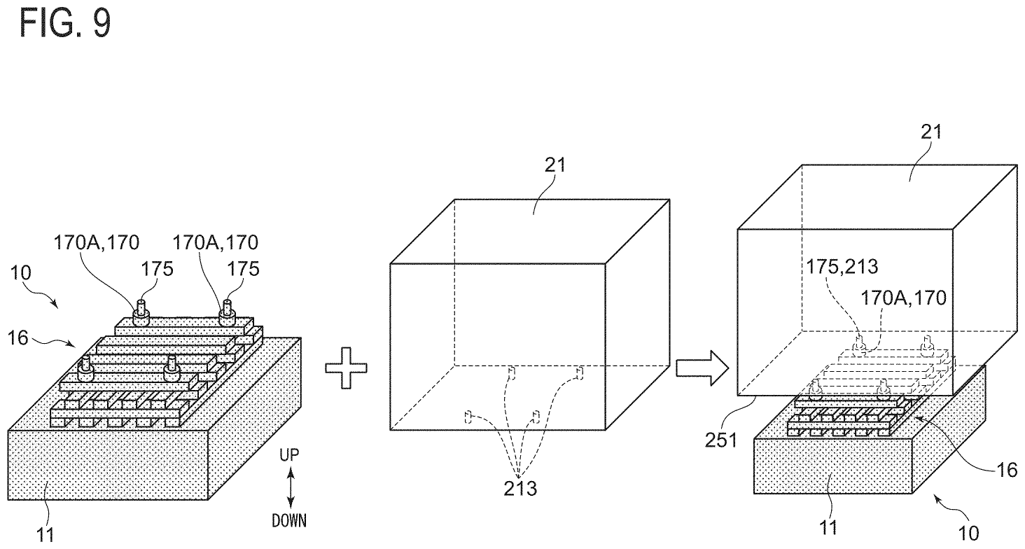

When a portion in which the second base portion 21 and the first engagement portion 16 are fitted together is provided in a contacting portion between the second base portion 21 and the first engagement portion 16, it is easy to realize positioning of the relative positions of the second base portion 21 and the first engagement portion 16 in the course of attaching the second base portion 21 to the second engagement portion 26. FIG. 9 is a diagram for describing an example in which a portion in which the second base portion 21 and the first engagement portion 16 are fitted together is provided in the contacting portion between the second base portion 21 and the first engagement portion 16. FIG. 9 is perspective views schematically illustrating the metal member 10, the second base portion 21, and the metal member 10 and the second base portion 21 when the second base portion 21 is brought into contact with the first engagement portion 16.

In the example illustrated in FIG. 9, a fitting projection portion 175 that protrudes from an apex of the frame 170A illustrated in FIG. 8 in an upward direction of the stacking direction is formed in each frame 170A. Moreover, in the example illustrated in FIG. 9, a fitting recess portion 213 in which the fitting projection portion 175 is inserted when the second base portion 21 and the first engagement portion 16 are brought into contact with each other is formed in a bottom surface of the second base portion 21 (that is, a surface corresponding to the first engagement portion 16). That is, in the example illustrated in FIG. 9, the bonding member 1 includes the fitting projection portion 175 that protrudes from the first engagement portion 16 toward the second base portion 21 over the interface 251 and the fitting recess portion 213 formed in the second base portion 21 so as to be fitted to the fitting projection portion 175.

When the second base portion 21 formed in advance, for example, is bonded using the resin 270 of the second engagement portion 26 as an adhesive, according to the example illustrated in FIG. 9, by fitting the fitting projection portion 175 and the fitting recess portion 213 together, it is possible to easily realize positioning of the second base portion 21 and the first engagement portion 16 (that is, the metal member 10).

A fitting projection portion that protrudes toward the first engagement portion 16 may be formed on a bottom surface of the second base portion 21, and a fitting recess portion depressed from the apex of the frame 170A in a downward direction of the stacking direction may be formed in the frame 170A so that the fitting relation over the interface 251 is reverse to that of the example illustrated in FIG. 9. That is, the bonding member 1 may include a fitting projection portion that protrudes from the second base portion 21 toward the first engagement portion 16 over the interface 251 and a fitting recess portion formed in the first engagement portion 16 so as to be fitted to the fitting projection portion.

(Shape of First Engagement Portion 16)

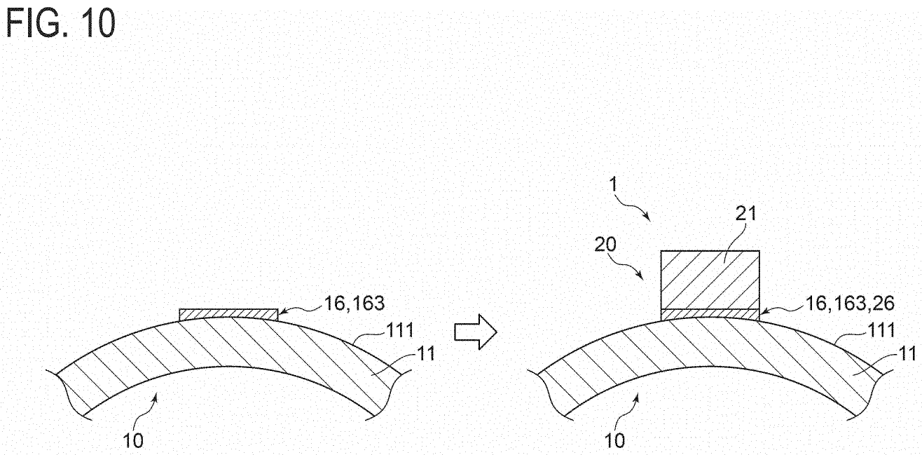

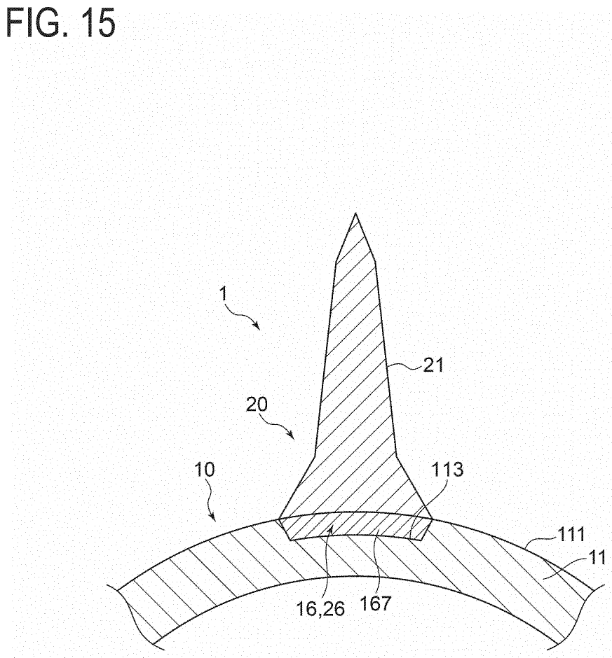

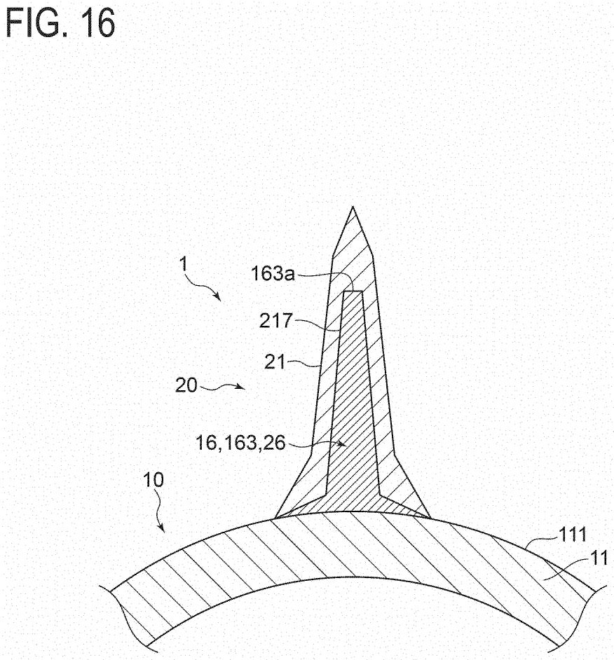

Hereinafter, various examples of the shape of the first engagement portion 16 will be described with reference to FIGS. 10 to 17. FIGS. 10 to 17 are schematic cross-sectional views for describing various examples of the shape of the first engagement portion 16. In FIGS. 10 to 17, an example in which the first base portion 11 is a member having a cylindrical shape, for example, and the second base portion 21 is disposed on the outer circumference of the cylinder of the first base portion 11 is illustrated. Moreover, in FIGS. 10 to 14, a cross-sectional view of the metal member 10 before the second base portion 21 is bonded is illustrated on the left side, and a cross-sectional view of the bonding member 1 after the second base portion 21 is bonded is illustrated on the right side. FIGS. 15 to 17 illustrate a cross-sectional view of the bonding member 1 after the second base portion 21 is bonded.

The first engagement portion 16 illustrated in FIGS. 10 to 17 may be the first engagement portion 16 according to any one of embodiments illustrated in FIGS. 1 to 9.

In the following description, it is assumed that a radial direction indicates the same direction as a radial direction of the cylinder of the first base portion 11 unless particularly stated otherwise. In the following description, it is assumed that an axial direction indicates the same direction as an axial direction of the cylinder of the first base portion 11 unless particularly stated otherwise. In the following description, it is assumed that a circumferential direction indicates the same direction as a circumferential direction of the cylinder of the first base portion 11 unless particularly stated otherwise.

In an embodiment illustrated in FIG. 10, the first engagement portion 16 is formed on a cylindrical circumferential surface 111 of the first base portion 11. In an embodiment illustrated in FIG. 10, although an outer surface in the radial direction of the first engagement portion 16 is a flat surface, the outer surface may be a curved surface.

In an embodiment illustrated in FIG. 10, the second base portion 21 is disposed on an outer surface in the radial direction of the first engagement portion 16.

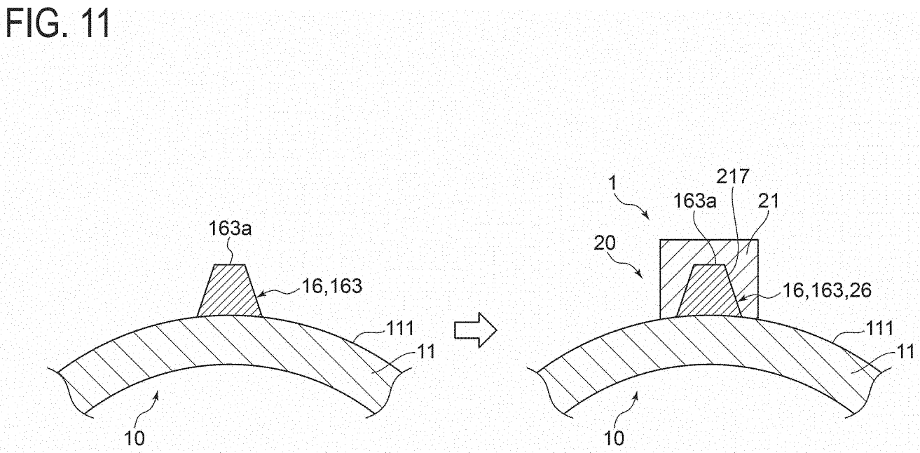

In an embodiment illustrated in FIGS. 11, 16, and 17, the first engagement portion 16 is formed in a cylindrical circumferential surface 111 of the first base portion 11. The first engagement portion 16 according to an embodiment illustrated in FIGS. 11, 16, and 17 has a large dimension in the radial direction as compared to the first engagement portion 16 according to the embodiment illustrated in FIG. 10, and is formed so that the dimension in the circumferential direction decreases as it approaches the outer side in the radial direction when seen from the axial direction, for example. For example, in an embodiment illustrated in FIGS. 11, 16, and 17, it is assumed that the first engagement portion 16 has a trapezoidal shape. That is, in the embodiment illustrated in FIGS. 11, 16, and 17, a projection portion 163 that protrudes from the cylindrical circumferential surface 111 of the first base portion 11 toward the outer side in the radial direction is formed.

In the embodiment illustrated in FIGS. 11, 16, and 17, the second base portion 21 covers the first engagement portion 16 having a trapezoidal shape from the outer side.

In the embodiment illustrated in FIGS. 11, 16, and 17, the second base portion 21 has a recess portion 217 in which the projection portion 163 is inserted.

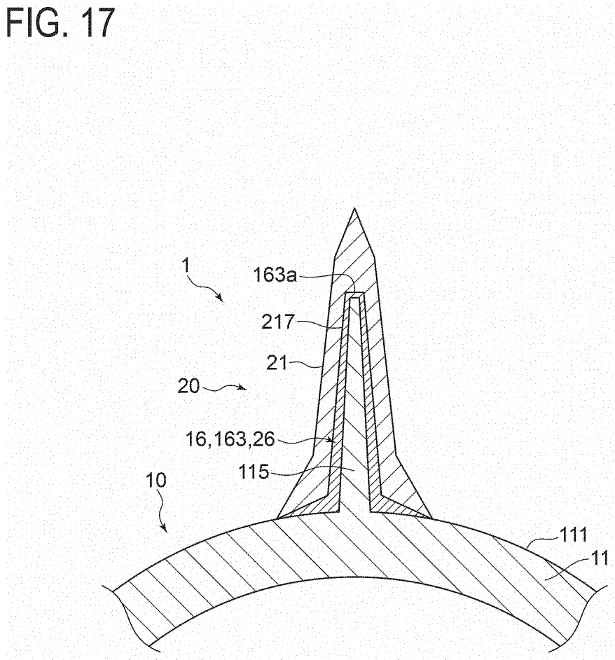

In the embodiment illustrated in FIG. 17, a projection portion 115 that protrudes from the circumferential surface 111 toward the outer side in the radial direction is formed in the first base portion 11. In the embodiment illustrated in FIG. 17, the first engagement portion 16 (the projection portion 163) is formed on the outer side of the projection portion 115.

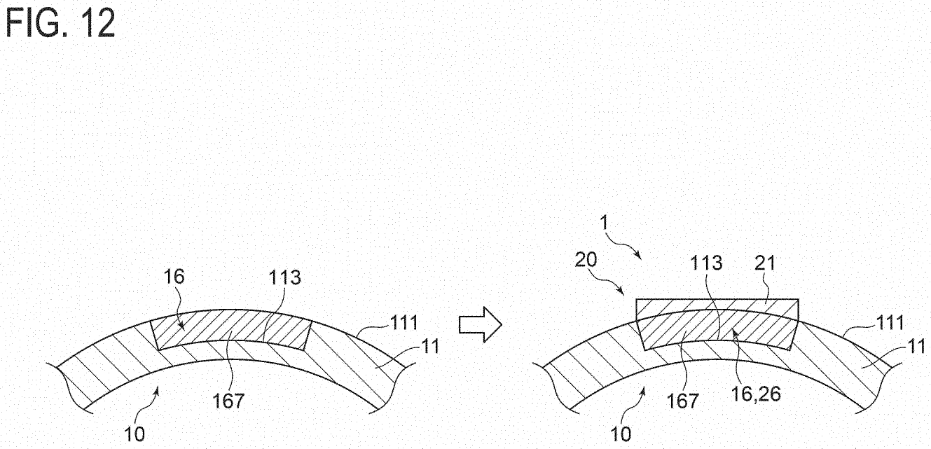

In an embodiment illustrated in FIGS. 12, 13, and 15, the first engagement portion 16 is formed on the inner side in the radial direction of the first base portion 11 than the cylindrical circumferential surface 111 of the first base portion 11. That is, in the embodiment illustrated in FIGS. 12, 13, and 15, a recess portion 113 depressed toward the inner side in the radial direction is formed in the first base portion 11, and the first engagement portion 16 is formed inside the recess portion 113. That is, in the embodiment illustrated in FIGS. 12, 13, and 15, a base end 167 of the first engagement portion 16 enters into the recess portion 113 of the first base portion.

In the embodiment illustrated in FIGS. 12, 13, and 15, although the outer surface in the radial direction of the first engagement portion 16 is the same cylindrical surface as the cylindrical circumferential surface 111 of the first base portion 11, the outer surface may be a flat surface.

In the embodiment illustrated in FIGS. 12, 13, and 15, the second base portion 21 is disposed on the outer surface in the radial direction of the first engagement portion 16.

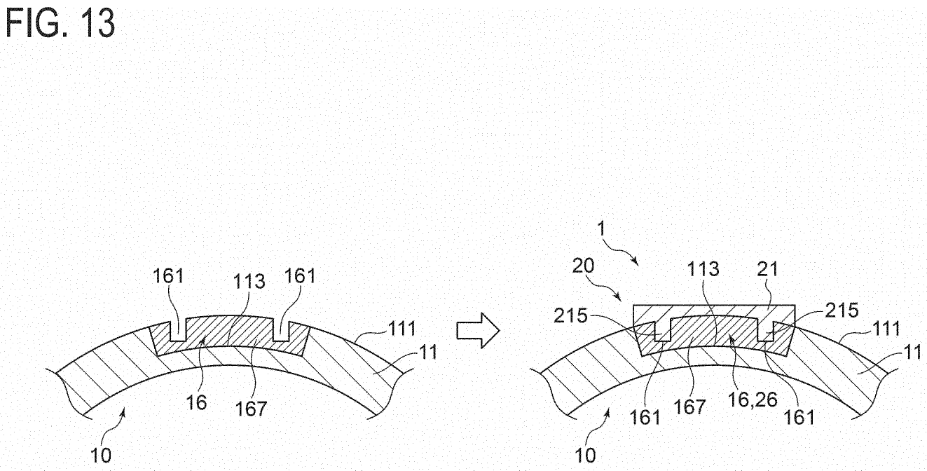

In the embodiment illustrated in FIG. 13, at least one recess portion 161 depressed toward the inner side in the radial direction from the circumferential surface of the first engagement portion 16 is formed in the first engagement portion 16 of the embodiment illustrated in FIG. 12.

In the embodiment illustrated in FIG. 13, the second base portion 21 has at least one projection portion 215 inserted into the recess portion 161.

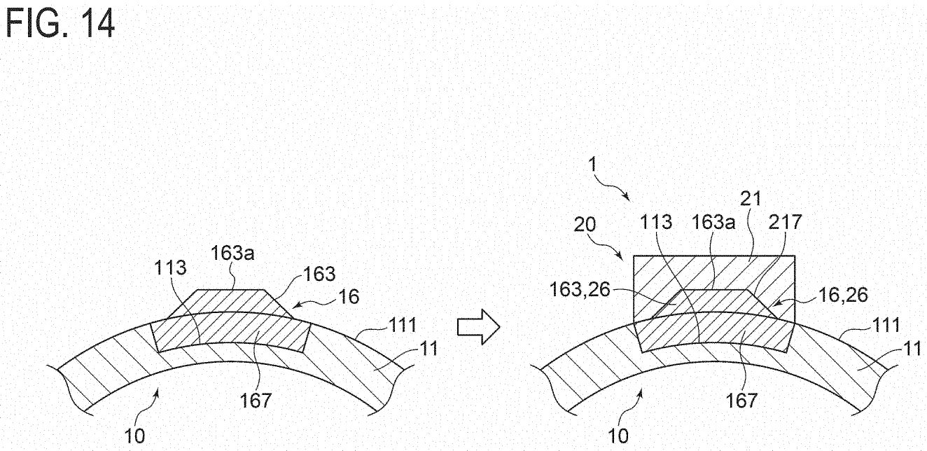

In the embodiment illustrated in FIG. 14, the recess portion 113 depressed toward the inner side in the radial direction is formed in the first base portion 11, and the first engagement portion 16 is formed inside the recess portion 113. That is, in the embodiment illustrated in FIG. 14, the base end 167 of the first engagement portion 16 enters into the recess portion 113 of the first base portion.

In the embodiment illustrated in FIG. 14, at least one projection portion 163 that protrudes toward the outer side in the radial direction from the circumferential surface of the first engagement portion 16 is formed in the first engagement portion 16 of the embodiment illustrated in FIG. 12.

In the embodiment illustrated in FIG. 14, the second base portion 21 is disposed in an outer surface in the radial direction of the first engagement portion 16.

In the embodiment illustrated in FIG. 14, the second base portion 21 has at least one recess portion 217 in which the projection portion 163 is inserted.

In the embodiment illustrated in FIGS. 10, 11, 13, 14, 16, and 17, the first engagement portion 16 has at least one recess portion 161 in which an outer shape of the first engagement portion 16 has a depressed shape or at least one projection portion 163 in which the outer shape has a protruding shape.

In the embodiment illustrated in FIGS. 10, 11, 13, 14, 16, and 17, the second engagement portion 26 engages with the first engagement portion 16 at least in a forming region of the recess portion 161 or a forming region of the projection portion 163.

In the embodiment illustrated in FIGS. 10, 11, 13, 14, 16, and 17, the second base portion 21 is connected to the second engagement portion 26 at least in the recess portion 161 or the projection portion 163.

In this way, since the engagement region of the first engagement portion 16 and the second engagement portion 26 is easily increased, it is easy to secure the bonding strength between the metal member 10 and the resin member 20.

In the embodiment illustrated in FIGS. 11, 14, 16, and 17, the first engagement portion 16 has the projection portion 163.

In the embodiment illustrated in FIGS. 11, 14, 16, and 17, the projection portion 163 has at least the distal end 163a which is covered by the second base portion 21. That is, in the embodiment illustrated in FIGS. 11, 14, 16, and 17, the projection portion 163 is inserted into the recess portion 217 of the second base portion 21.

In this way, it is easy to realize positioning of the relative positions of the metal member 10 and the resin member 20.

In the embodiment illustrated in FIG. 17, the first base portion 11 has the projection portion 115 which is a portion thereof and which enters into the projection portion 163 toward the distal end 163a of the projection portion 163 of the first engagement portion 16.

In this way, due to the projection portion 115 of the first base portion 11 entering into the projection portion 163 of the first engagement portion 16, it is possible to easily reinforce the strength of the projection portion 163 of the first engagement portion 16.

In the embodiment illustrated in FIG. 13, the first engagement portion 16 has the recess portion 161. In the embodiment illustrated in FIG. 13, the projection portion 215 which is a portion of the second base portion 21 is inserted into the recess portion 161.

In this way, as illustrated in FIG. 13, even when the second base portion 21 is a relative thin member, for example, it is easy to form the projection portion 215 which is a portion inserted into the recess portion 161 in the second base portion 21. Therefore, even when the second base portion 21 is a relatively thin member, for example, it is easy to realize positioning of the relative positions of the metal member 10 and the resin member 20.

In the embodiment illustrated in FIGS. 12 to 15, the base end 167 of the first engagement portion 16 enters into the recess portion 113 of the first base portion 11.

In this way, even if it is difficult to provide such a first engagement portion 16 that protrudes from the first base portion 11 toward the second base portion 21 due to restrictions such as the shape or the like of the second base portion 21, for example, when the first engagement portion 16 is formed in the recess portion 113 of the first base portion 11, since it is easy to increase an engagement region between the first engagement portion 16 and the second engagement portion 26, it is easy to secure the bonding strength between the metal member 10 and the resin member 20.

In the embodiment illustrated in FIGS. 12 to 15, it is possible to form the recess portion 113 in advance by performing mechanical processing such as cutting or plastic working on the first base portion 11. In the embodiment illustrated in FIGS. 12 to 15, the base end 167 including a three-dimensional structure that forms the plurality of cavities 181 communicating with each other therein may be formed in the recess portion 113 formed in advance according to additive manufacturing, for example.

At least one of the second base portion 21 or the second engagement portion 26 according to some embodiments described above may include fiber in the resin serving as a base material thereof, and the strength of the resin member 20 can be improved by the fiber.

Here, the fiber included in the base material of the resin member 20 may be fiber of carbon, glass, ceramics or the like. Moreover, when at least one of the second base portion 21 and the second engagement portion 26 is formed by injection molding, the fiber may be fiber having a relative short length which does not cause any problem when performing injection molding.

The length of the fiber is not particularly limited when the second base portion 21 is manufactured using a prepreg laminate formed by stacking a plurality of prepreg sheets obtained by die-cutting a thin sheet of carbon fiber reinforced plastics (CFRP), for example.

(Method for Manufacturing Bonding Member 1)

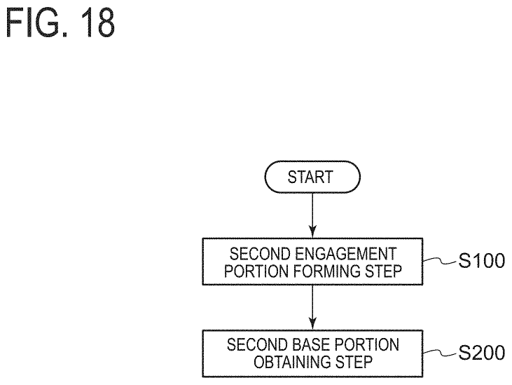

Hereinafter, a method for manufacturing the bonding member 1 according to some embodiments described above will be described. FIG. 18 is a flowchart of a method for manufacturing the bonding member 1 according to some embodiments described above. The method for manufacturing the bonding member 1 according to some embodiments includes a second engagement portion forming step S100 and a second base portion acquiring step S200.

The second engagement portion forming step S100 is a step for filling the resin 270 in the plurality of cavities 181 of the first engagement portion 16 including a three-dimensional structure that is formed by the frame 170 made of metal and provided integrally with the first base portion 11 made of metal and forms the plurality of cavities 181 communicating with each other therein to form the second engagement portion 26.

In the second engagement portion forming step S100, the metal member 10 is set on an injection molding die (not illustrated), for example, and the resin 270 is injected by an injection molding apparatus (not illustrated) whereby the resin 270 can be filled in the cavity 181.

The second base portion acquiring step S200 is a step of obtaining the second base portion 21 made of resin and provided integrally with the second engagement portion 26.

In this way, the resin 270 is filled in the plurality of cavities 181 of the first engagement portion 16 provided integrally with the first base portion 11 to form the second engagement portion 26 and obtain the second base portion 21 made of resin and provided integrally with the second engagement portion 26 whereby the bonding member in which the first base portion 11 made of metal and the second base portion 21 made of resin is obtained.

The resin 270 may be filled in the plurality of cavities 181 to form the second engagement portion 26 and the second base portion 21 may be made of resin of the same type as the resin 270.

In this way, for example, the first base portion 11 and the first engagement portion 16 made of metal and formed integrally are set on an injection molding die (not illustrated), and a resin is injected by an injection molding apparatus (not illustrated) to obtain the second engagement portion 26 and the second base portion 21. In this way, the bonding member 1 in which the first base portion 11 made of metal and the second base portion 21 made of resin are bonded is obtained easily.

The second base portion 21 and the first engagement portion 16 may be attached by the resin 270 filled in the plurality of cavities 181.

In this way, for example, the second base portion 21 formed in advance is bonded to the resin 270 in the cavity 181 of the first engagement portion 16, whereby the bonding member 1 in which the second base portion 21 is bonded to the first base portion 11 and the first engagement portion 16 made of metal and formed integrally is obtained. In this case, by using an adhesive as the resin 270 of the second engagement portion 26, the bonding member 1 is obtained easily.

The present invention is not limited to the above-described embodiments but includes modifications of the above-described embodiments and appropriate combinations of these modifications.

For example, in some embodiments illustrated in FIGS. 1 to 9, for the convenience of explanation, the upper surface of the first base portion 11 is a flat surface, and the first extension portion 171 and the second extension portion 172 extend in parallel along the upper surface. Moreover, for example, in some embodiments illustrated in FIGS. 1 to 9, the respective layers of the first engagement portion 16 are staked from the first base portion 11 toward the second base portion 21 of the resin member 20. Moreover, for example, in some embodiments illustrated in FIGS. 1 to 9, the first extension portion 171 and the second extension portion 172 extend in directions orthogonal to each other. However, the present invention is not limited to these aspects.

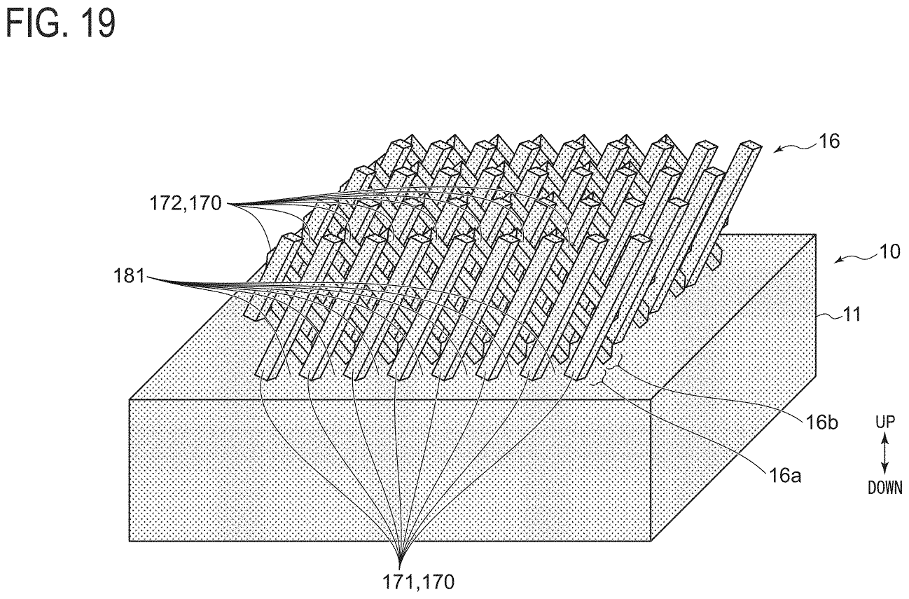

FIG. 19 is a perspective view illustrating a modification of the first engagement portion 16.

For example, as illustrated in FIG. 19, the first extension portion 171 and the second extension portion 172 may not be orthogonal to each other. That is, the angle between the extension direction of the first extension portion 171 and the extension direction of the second extension portion 172 may be an angle other than 90°.

For example, as illustrated in FIG. 19, the stacking direction of the respective layers of the first engagement portion 16 may be a direction different from the direction (an upward direction in FIG. 19) from the first base portion 11 toward the second base portion 21 of the resin member 20 (not illustrated in FIG. 19). In a modification illustrated in FIG. 19, although the stacking direction of the respective layers such as the first layer 16a and the second layer 16b of the first engagement portion 16 is a direction along the extension direction of the upper surface of the first base portion 11, the stacking direction may be a direction obliquely intersecting the upper surface of the first base portion 11.

That is, for example, similarly to the first engagement portion 16 illustrated in FIG. 19, the second layer 16b may be stacked on the first layer 16a in a direction intersecting the direction from the first base portion 11 toward the second base portion 21.

For example, as illustrated in FIG. 19, the first extension portion 171 and the second extension portion 172 may extend in a direction intersecting the upper surface of the first base portion 11.

For example, in the bonding member 1 according to some embodiments illustrated in FIGS. 2 and 3, during additive manufacturing, the first extension portion 171 and the second extension portion 172 extend in the first direction Dr1 and the second Dr2 (that is, a horizontal direction) orthogonal to a vertical direction immediately above in the vertical direction of the cavity 181. As described above, it is generally difficult to form the first engagement portion 16 having a parallel-cross shape having such an overhang portion that extends in a horizontal direction immediately above in the vertical direction of the cavity 181 during additive manufacturing according to additive manufacturing such as powder bed fusion or metal deposition.

However, for example, as illustrated in FIG. 19, if the first engagement portion 16 has the first extension portion 171 and the second extension portion 172 extending in a direction intersecting the upper surface of the first base portion 11, since the first extension portion 171 and the second extension portion 172 extend in a direction intersecting a horizontal direction during additive manufacturing, the first engagement portion 16 is formed easily according to additive manufacturing such as powder bed fusion or metal deposition.

According to additive manufacturing of binder jetting, the first engagement portion 16 having a parallel-cross shape having such an overhang portion as the first engagement portion 16 illustrated in FIGS. 2 and 3 can be formed relatively easily.

The three-dimensional structure of the first engagement portion 16 is not limited to a parallel-cross structure formed by at least one first extension portion 171 extending in the first direction Dr1 and at least one second extension portion 172 extending in the second direction Dr2. That is, the first engagement portion 16 may include a three-dimensional structure that forms a plurality of cavities 181 communicating with each other inside the frame 170.

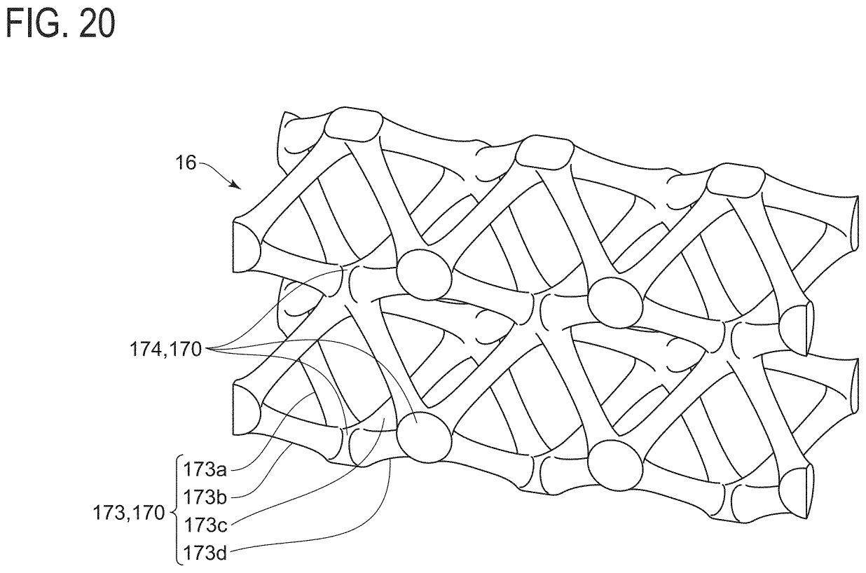

FIG. 20 is a perspective view illustrating an example of the first engagement portion 16 having a three-dimensional structure rather than a simple parallel-cross structure. In FIG. 20, a portion of the first engagement portion 16 is illustrated. In an embodiment illustrated in FIG. 20, the frame 170 includes shaft portions 173 extending in different directions and connecting portions 174 to which ends of different shaft portions 173 are connected. In an embodiment illustrated in FIG. 20, the shaft portion 173 includes four shaft portions 173a to 173d extending in different directions, for example.

For example, like the first engagement portion 16 illustrated in FIG. 20, the first engagement portion 16 may include at least a first shaft-shaped member which is a plurality of first shaft portions 173 extending in a first extension direction and a second shaft-shaped member which is a plurality of second shaft portions 173 extending in a second extension direction intersecting the first extension direction. At least one of the plurality of first shaft portions 173 and at least one of the plurality of second shaft portions 173 may be connected to the connecting portion 174.

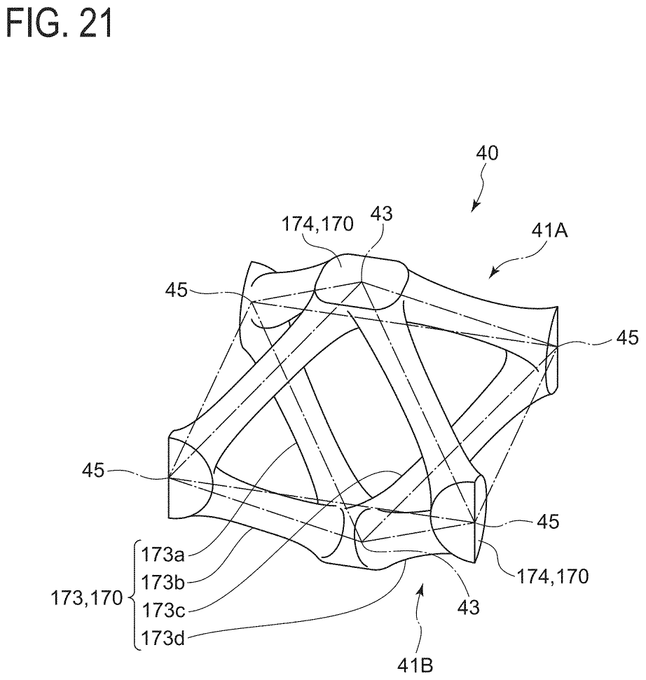

FIG. 21 is a perspective view of a unit grid of a three-dimensional structure according to an embodiment illustrated in FIG. 20. In an embodiment illustrated in FIG. 20, as illustrated in FIG. 21, a unit grid 40 of a three-dimensional structure has such a shape that bottom surfaces of two quadrangular pyramids 41A and 41B are superimposed, and the shaft portions 173 are disposed at a position corresponding to a segment connecting an apex 43 of each of the quadrangular pyramids 41A and 41B and a corner 45 of the bottom surface.

When the first engagement portion 16 has such a unit grid 40 as illustrated in FIGS. 20 and 21, since the shaft portion 173 extends in a direction intersecting a horizontal direction during additive manufacturing, the first engagement portion 16 is formed easily according to additive manufacturing such as powder bed fusion or metal deposition.

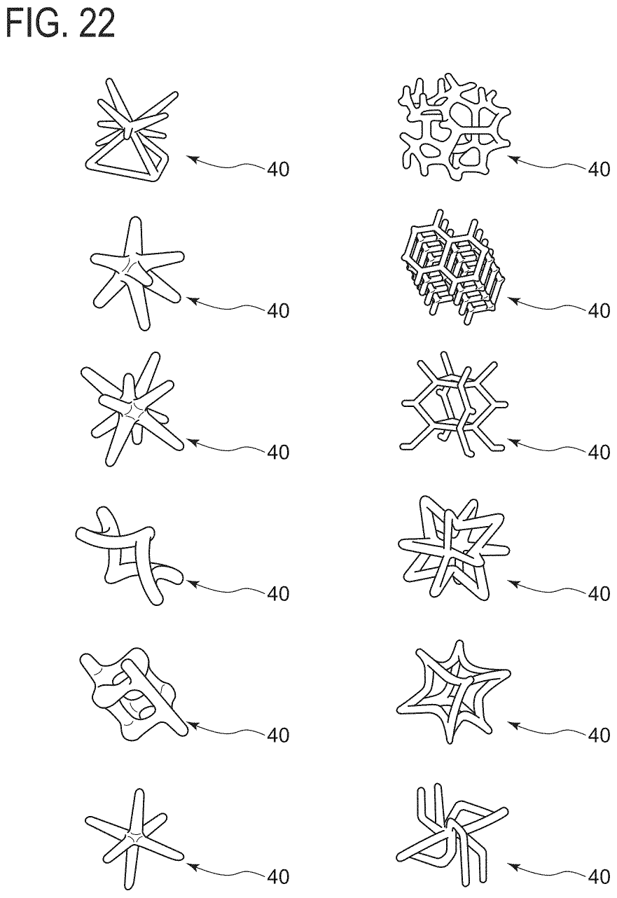

The shape of the unit grid 40 is not limited to the shape of the unit grid 40 illustrated in FIG. 21 but various shapes may be employed. FIG. 22 is a diagram illustrating some examples of the shape of the unit grid 40. The three-dimensional structure of the first engagement portion 16 may have a shape in which any one of the unit grids 40 illustrated in FIGS. 21 and 22 or a plurality of unit grids 40 appear repeatedly.

In some shaft portions 173, one end thereof may not be connected to the other shaft portion 173. The shaft portion 173 may not extend linearly but may have a curved portion. The shaft portion 173 may have a diameter that is constant along the extension direction and may have a diameter that changes depending on the position in the extension direction.

The position at which the plurality of shaft portions 173 are connected to each other is not limited to the end of the shaft portion 173 but may be a position between both ends of the shaft portion 173.

A modification related to the three-dimensional structure of the first engagement portion 16 does not exclude a structure other than these modifications. The three-dimensional structure of the first engagement portion 16 may include any one of various three-dimensional structures having a three-dimensional network structure having continuous pores.

1. A bonding member comprising:
a metal member including a first base portion made of metal and a first engagement portion made of metal and provided integrally with the first base portion; and
a resin member including a second base portion made of resin and a second engagement portion made of resin and provided integrally with the second base portion so as to engage with the first engagement portion, wherein
the first engagement portion includes a three-dimensional structure formed by a frame to form a plurality of cavities communicating with each other inside the frame,
the second engagement portion includes a resin filled in the plurality of cavities of the three-dimensional structure, and
a ratio of the frame per unit volume including the cavity and the frame in the first engagement portion gradually increases toward the first base portion while fluctuating.

2. The bonding member according to claim 1, wherein
the first engagement portion has at least one of a recess portion in which an outer shape of the first engagement portion has a depressed shape or a projection portion in which the outer shape has a protruding shape,
the second engagement portion engages with the first engagement portion at least in a forming region of the recess portion or a forming region of the projection portion, and
the second base portion is connected to the second engagement portion at least in the recess portion or the projection portion.

3. The bonding member according to claim 2, wherein
the first engagement portion has the projection portion, and
the projection portion has at least a distal end which is covered by the second base portion.

4. The bonding member according to claim 3, wherein
a portion of the first base portion penetrates into the projection portion toward the distal end of the projection portion.

5. The bonding member according to claim 2, wherein
the first engagement portion has the recess portion, and
a portion of the second base portion is inserted into the recess portion.

6. The bonding member according to claim 1, wherein
a base end of the first engagement portion penetrates into the recess portion of the first base portion.

7. The bonding member according to claim 1, wherein
the first engagement portion has at least a first layer and a second layer stacked on the first layer, and
the frame includes at least one first extension portion extending in a first direction in the first layer and at least one second extension portion extending in a second direction intersecting the first direction in the second layer.

8. The bonding member according to claim 7, wherein
the first layer is located closer to the first base portion than the second layer, and
a ratio of the frame per unit volume in the first layer is larger than a ratio of the frame per unit volume in the second layer.

9. The bonding member according to claim 8, wherein
a cross-sectional area of the first extension portion in a cross-section orthogonal to an extension direction of the first extension portion is larger than a cross-sectional area of the second extension portion in a cross-section orthogonal to an extension direction of the second extension portion.

10. The bonding member according to claim 8, wherein
the number of first extension portions is larger than the number of second extension portions.

11. The bonding member according to claim 7, wherein
the second layer is stacked on the first layer in a direction intersecting a direction from the first base portion toward the second base portion.

12. The bonding member according to claim 1, wherein
the first engagement portion includes at least a plurality of first shaft-shaped members extending in a first extension direction and a plurality of second shaft-shaped members extending in a second extension direction intersecting the first extension direction, and
at least one of the plurality of first shaft-shaped members and at least one of the plurality of second shaft-shaped members are connected by a connecting portion.

13. The bonding member according to claim 1, wherein
a resin constituting the second engagement portion is a resin of the same type as a resin constituting the second base portion.

14. The bonding member according to claim 1, wherein
a resin constituting the second engagement portion is a resin of a different type from a resin constituting the second base portion.

15. The bonding member according to claim 14, wherein
a ratio of an area of a metal to an interface at which the second base portion makes contact with the first engagement portion or the second engagement portion is smaller than an average value of the ratio of the frame per unit volume including the cavity and the frame in the first engagement portion.

16. The bonding member according to claim 15, further comprising:
a fitting projection portion that protrudes from the second base portion toward the first engagement portion over the interface or protrudes from the first engagement portion toward the second base portion over the interface; and
a fitting recess portion formed in the second base portion or the first engagement portion so as to be fitted to the fitting projection portion.

17. The bonding member according to claim 1, wherein
the first engagement portion has a pillar-shaped inner circumferential wall surface extending along a direction from the first base portion toward the second base portion and surrounding the cavity, and
in a cross-section orthogonal to the direction from the first base portion toward the second base portion, a cross-sectional area of a region surrounded by the inner circumferential wall surface gradually increases toward the first base portion while fluctuating.

18. A bonding member manufacturing method comprising:
filling a resin in a plurality of cavities to form a second engagement portion with respect to a first engagement portion including a three-dimensional structure formed by a frame made of metal and provided integrally with a first base portion made of metal to form the plurality of cavities communicating with each other therein; and
obtaining a second base portion made of resin and provided integrally with the second engagement portion.

19. The bonding member manufacturing method according to claim 18, wherein
the resin is filled into the plurality of cavities to form the second engagement portion and the second base portion is formed by the resin.

20. The bonding member manufacturing method according to claim 18, wherein
the second base portion and the first engagement portion are attached by the resin filled into the plurality of cavities.
